(19) United States
(12) Patent Application Publication
(10) Pub. No.: US 2022/0369136 A1
(43) Pub. Date: Nov. 17, 2022

(54) TRANSMISSION PROCEDURES FOR SMALL DATA TRANSMISSIONS

(71) Applicant: Fraunhofer-Gesellschaft zur Foerderung der angewandten Forschunge.V., Munich (DE)

(72) Inventors: Baris GOEKTEPE, Berlin (DE); Nithin SRINIVASAN, Berlin (DE); Thomas FEHRENBACH, Berlin (DE); Thomas WIRTH, Berlin (DE); Thomas SCHIERL, Berlin (DE); Cornelius HELLGE, Berlin (DE)

(21) Appl. No.: 17/729,687

(22) Filed: Apr. 26, 2022

Related U.S. Application Data
(63) Continuation of application No. PCT/EP2020/080158, filed on Oct. 27, 2020.

(30) Foreign Application Priority Data
Oct. 29, 2019 (EP) 19205888.1

(51) Int. Cl. H04W 24/08; H04W 76/20; H04W 68/00; H04L 1/18; H04L 1/08

(52) U.S. Cl. CPC H04W 24/08; H04W 76/20; H04W 68/005; H04L 1/1812; H04L 1/08

(57) ABSTRACT

A user device, UE, for a wireless communication system is described. The wireless communication system includes one or more base stations. The UE is in an RRC_INACTIVE state or in an RRC_IDLE state and is to monitor one or more paging occasions. The UE is to perform one or more uplink, UL, transmissions to the base station without entering an RRC_CONNECTED state, e.g., using a configured grant, CG, or pre-configured resources. The UE is to monitor one or more paging occasions following the one or more UL transmissions for a message from the base station, the message being associated with feedback information, e.g., HARQ feedback formation, for the one or more UL transmissions.

### CROSS-REFERENCE TO RELATED APPLICATIONS

This application is a continuation of copending International Application No. PCT/EP2020/080158, filed Oct. 27, 2020, which is incorporated herein by reference in its entirety, and additionally claims priority from European Application No. 19205888.1, filed Oct. 29, 2019, which is also incorporated herein by reference in its entirety.

### FIELD OF THE INVENTION

The present application relates to the field of wireless communication systems or networks, more specifically to enhancements or improvements regarding the transmission of data between a user device, UE, and a base station without the need for the UE to transition to the RRC_CONNECTED state. Embodiments of the present invention concern different approaches for providing a feedback for such transmission, like a hybrid automatic repeat request, HARQ, feedback.

### BACKGROUND OF THE INVENTION

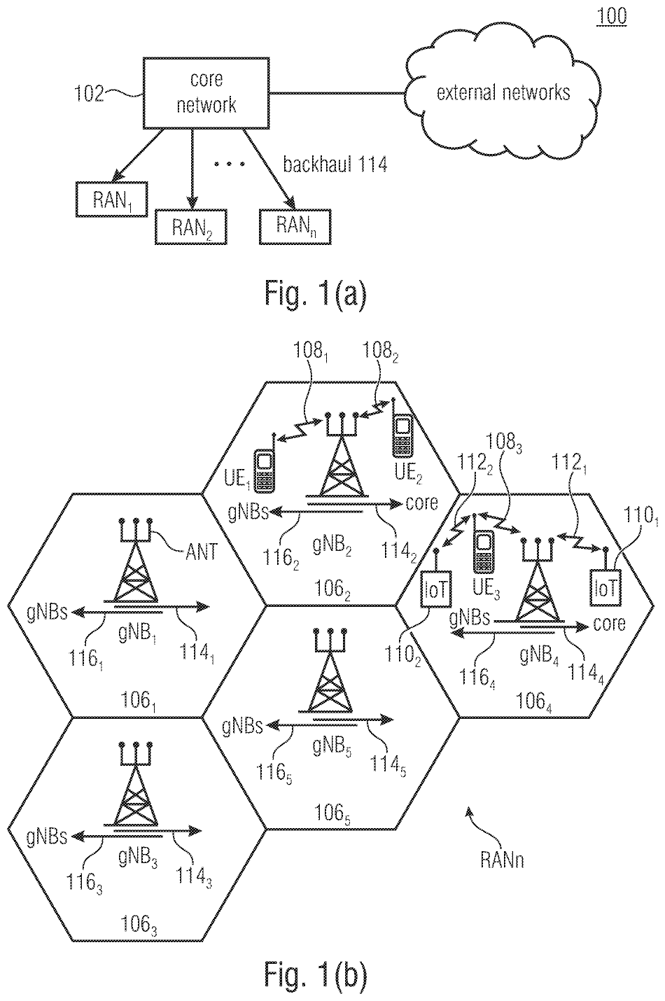

FIG. 1 is a schematic representation of an example of a terrestrial wireless network 100 including, as is shown in FIG. 1(a), a core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device (D2D) communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB) and one or more of a system information block (SIB), the physical downlink, uplink and sidelink control channels (PDCCH, PUCCH, PSSCH) carrying for example the downlink control information (DCI), the uplink control information (UCI) and the sidelink control information (SCI). Note, the sidelink interface may a support 2-stage SCI. This refers to a first control region containing some parts of the SCI, and optionally, a second control region, which contains a second part of control information.

For the uplink, the physical channels may further include the physical random access channel (PRACH or RACH) used by UEs for accessing the network once a UE synchronized and obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. A frame may also consist of a smaller number of OFDM symbols, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations (not shown in FIG. 1), like femto or pico base stations.

In addition to the above described terrestrial wireless network also non-terrestrial wireless communication networks (NTN) exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

It is noted that the information in the above section is only for enhancing the understanding of the background of the invention and therefore it may contain information that does not form conventional technology that is already known to a person of ordinary skill in the art.

Starting from the conventional technology as described above, there may be a need for enhancements or improvements in the transmission of data, like the transmission of so-called small data, for which the UE does not transition to the RRC_CONNECTED state.

### SUMMARY

An embodiment may have a user device, UE, for a wireless communication system, the wireless communication system including one or more base stations, wherein the UE is in an RRC_INACTIVE state or in an RRC_IDLE state and is to monitor one or more paging occasions, wherein the UE is to perform one or more uplink, UL, transmissions to the base station without entering an RRC_CONNECTED state, e.g., using a configured grant, CG, or pre-configured resources, wherein the UE is to monitor one or more paging occasions following the one or more UL transmissions for a message from the base station, the message being associated with feedback information, e.g., HARQ feedback formation, for the one or more UL transmissions.

Another embodiment may have a user device, UE, for a wireless communication system, the wireless communication system including one or more base stations, wherein the UE is in an RRC_INACTIVE state or in an RRC_IDLE state and is to monitor one or more paging occasions, wherein the UE is to perform an uplink, UL, transmission to the base station without entering an RRC_CONNECTED state, e.g., using a configured grant, CG, or pre-configured resources, wherein the UE is to monitor one or more additional paging occasions following the one or more UL transmissions for a message from the base station, the message being associated with feedback information, e.g., HARQ feedback formation, for the one or more UL transmissions.

Another embodiment may have a user device, UE, for a wireless communication system, the wireless communication system including one or more base stations, wherein the UE is in an RRC_INACTIVE state or in an RRC_IDLE state and is to monitor one or more paging occasions, wherein the UE is to receive one or more downlink, DL, transmissions from the base station without entering an RRC_CONNECTED state, wherein the UE is to monitor one or more paging occasions for a message from the base station, the message
including a downlink, DL, transmission from the base station downlink, or
indicating that a configured or pre-configured set of resources is to be monitored for a further message, or indication a set of resources for a further message including a downlink, DL, transmission from the base station downlink.

Another embodiment may have a base station, BS, for a wireless communication system, wherein the BS is to receive one or more uplink, UL, transmissions from a user device, UE, the UE being in an RRC_INACTIVE state or in an RRC_IDLE state and not entering an RRC_CONNECTED state for the transmission, and wherein, following the one or more UL transmissions, the BS is to transmit a message to the UE at one or more paging occasions monitored by the UE, the message being associated with feedback information, e.g., HARQ feedback formation, for the one or more UL transmissions.

Another embodiment may have a base station, BS, for a wireless communication system, wherein the BS is to receive one or more uplink, UL, transmissions from a user device, UE, the UE being in an RRC_INACTIVE state or in an RRC_IDLE state and not entering an RRC_CONNECTED state for the transmission, and wherein, following the one or more UL transmissions, the BS is to transmit a message to the UE at one or more additional paging occasions monitored by the UE, the message being associated with feedback information, e.g., HARQ feedback formation, for the one or more UL transmissions.

Another embodiment may have a base station, BS, for a wireless communication system, wherein the BS is to transmit one or more downlink, DL, transmissions to a user device, UE, the UE being in an RRC_INACTIVE state or in an RRC_IDLE state and not entering an RRC_CONNECTED state for the transmission, and wherein the BS is to transmit a message to the UE at one or more paging occasions monitored by the UE, the message
including the downlink, DL, transmission from the base station downlink, or
indicating a set of resources for a further message, like a DFI, including a downlink, DL, transmission from the base station downlink.

According to another embodiment, a wireless communication system may have any of the above inventive user devices, UE and/or any of the above inventive base stations, BS.

According to another embodiment, a method for a wireless communication system, the wireless communication system including one or more base stations, and a user device, UE, being in an RRC_INACTIVE state or in an RRC_IDLE state, may have the steps of: monitoring, by the UE, one or more paging occasions, performing, by the UE, one or more uplink, UL, transmissions to the base station without entering an RRC_CONNECTED state, e.g., using a configured grant, CG, or pre-configured resources, monitoring, by the UE, one or more paging occasions following the one or more UL transmissions for a message from the base station, the message being associated with feedback information, e.g., HARQ feedback formation, for the one or more UL transmissions.

According to another embodiment, a method for a wireless communication system, the wireless communication system including one or more base stations, and a user device, UE, being in an RRC_INACTIVE state or in an RRC_IDLE state, may have the steps of: monitoring, by the UE, one or more paging occasions, performing, by the UE, an uplink, UL, transmission to the base station without entering an RRC_CONNECTED state, e.g., using a configured grant, CG, or pre-configured resources, monitoring, by the UE, one or more additional paging occasions following the one or more UL transmissions for a message from the base station, the message being associated with feedback information, e.g., HARQ feedback formation, for the one or more UL transmissions.

According to another embodiment, a method for a wireless communication system, the wireless communication system including one or more base stations, and a user device, UE, being in an RRC_INACTIVE state or in an RRC_IDLE state, may have the steps of: monitoring, by the UE, one or more paging occasions, receiving, by the UE, one or more downlink, DL, transmissions from the base station without entering an RRC_CONNECTED state, monitoring, by the UE, one or more paging occasions for a message from the base station, the message
including a downlink, DL, transmission from the base station downlink, or
indicating that a configured or pre-configured set of resources is to be monitored for a further message, or indication a set of resources for a further message including a downlink, DL, transmission from the base station downlink.

According to another embodiment, a method for a wireless communication system, the wireless communication system including one or more base stations and a user device, may have the steps of: receiving, by the BS, one or more uplink, UL, transmissions from the user device, UE, the UE being in an RRC_INACTIVE state or in an RRC_IDLE state and not entering an RRC_CONNECTED state for the transmission, and following the one or more UL transmissions, transmitting, by the BS, a message to the UE at one or more paging occasions monitored by the UE, the message being associated with feedback information, e.g., HARQ feedback formation, for the one or more UL transmissions.

According to another embodiment, a method for a wireless communication system, the wireless communication system including one or more base stations and a user device, may have the steps of: receiving, by the BS, one or more uplink, UL, transmissions from a user device, UE, the UE being in an RRC_INACTIVE state or in an RRC_IDLE state and not entering an RRC_CONNECTED state for the transmission, and following the one or more UL transmissions, transmitting, by the BS, a message to the UE at one or more additional paging occasions monitored by the UE, the message being associated with feedback information, e.g., HARQ feedback formation, for the one or more UL transmissions.

According to another embodiment, a method for a wireless communication system, the wireless communication system including one or more base stations and a user device, may have the steps of: transmitting, by the BS, one or more downlink, DL, transmissions to the user device, UE, the UE being in an RRC_INACTIVE state or in an RRC_IDLE state and not entering an RRC_CONNECTED state for the transmission, and transmitting, by the BS, a message to the UE at one or more paging occasions monitored by the UE, the message
including the downlink, DL, transmission from the base station downlink, or
indicating a set of resources for a further message, like a DFI, including a downlink, DL, transmission from the base station downlink.

Another embodiment may have a non-transitory digital storage medium having stored thereon a computer program for performing any of the above inventive methods, when said computer program is run by a computer.

### BRIEF DESCRIPTION OF THE INVENTION

Embodiments of the present invention are now described in further detail with reference to the accompanying drawings, in which:

FIG. 1a-b shows a schematic representation of an example of a wireless communication system;

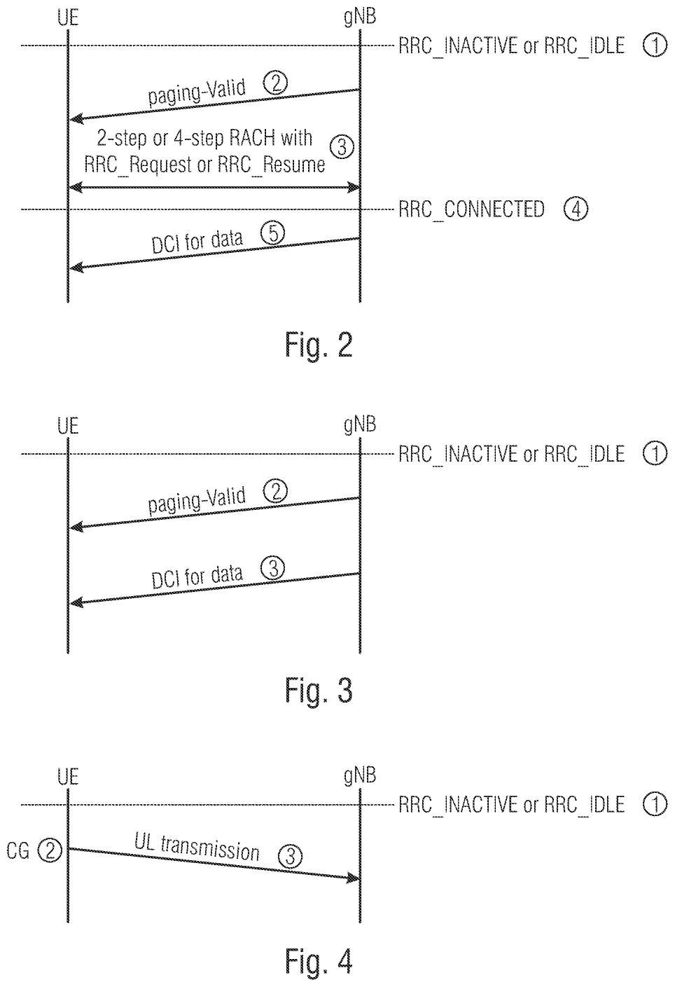

FIG. 2 illustrates a conventional or legacy downlink transmission for data entailing a change of the RRC state of a UE;

FIG. 3 illustrates an example for a DL transmission for small data without the UE changing the RRC state;

FIG. 4 illustrates, schematically, an uplink transmission from the UE to the gNB without the UE changing its RRC state;

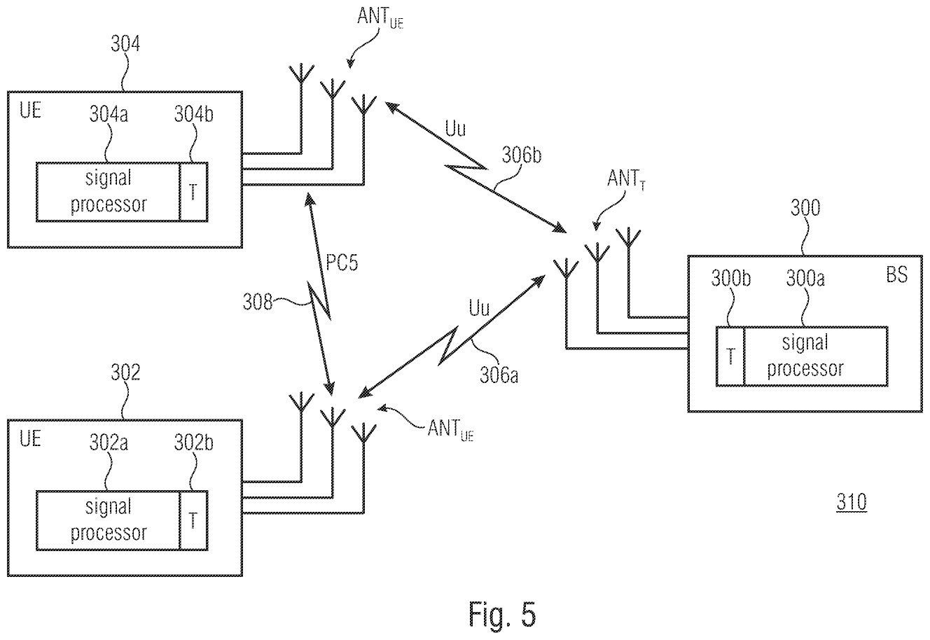

FIG. 5 is a schematic representation of a wireless communication system including a transmitter, like a base station, and one or more receivers, like user devices, UEs;

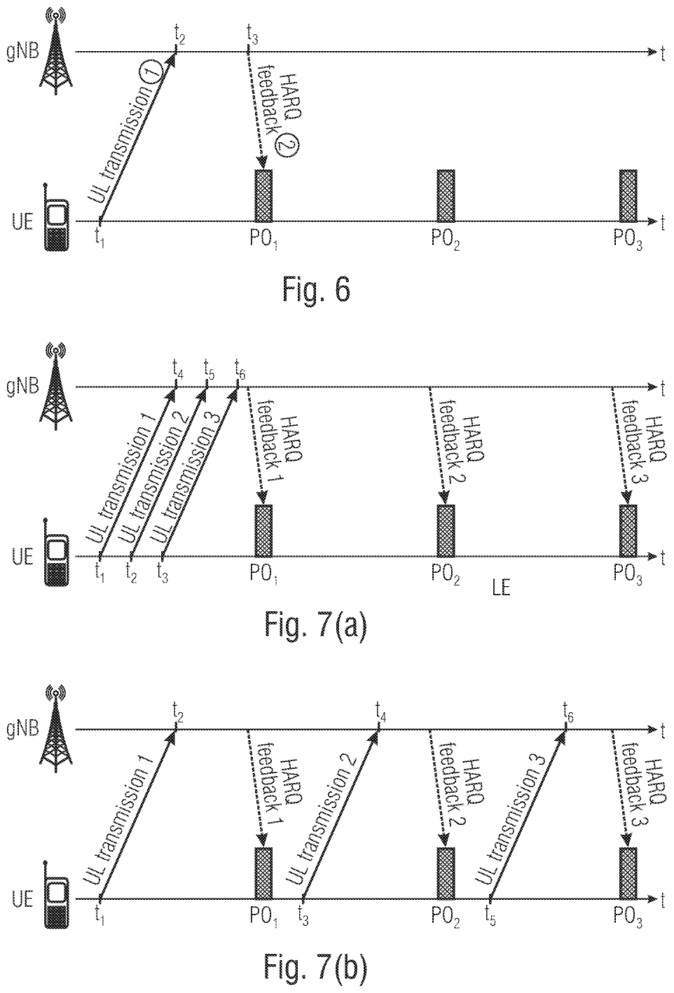

FIG. 6 illustrates an embodiment for a HARQ feedback in a paging DCI during a UE paging occasion, PO;

FIG. 7a-b illustrates other embodiments for a feedback in the paging DCI during the UE PO for each of a plurality of uplink transmissions from the UE to the gNB;

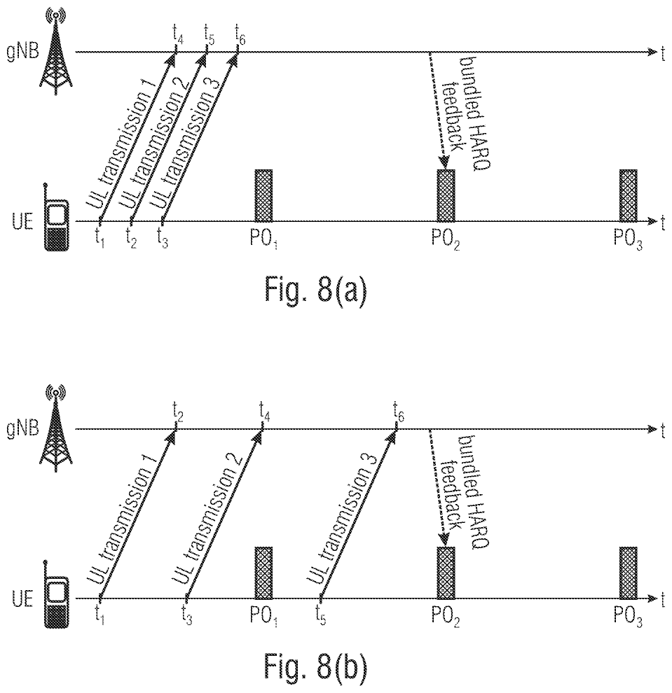

FIG. 8a-b illustrates embodiments employing a bundled feedback for a plurality of uplink transmissions;

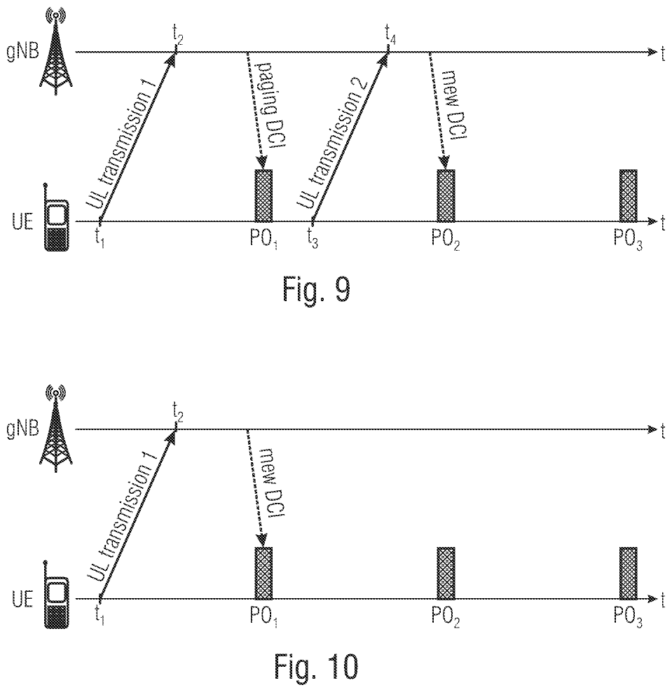

FIG. 9 illustrates an embodiment employing a new DCI and an existing paging DCI for signaling a NACK/ACK for a transmission;

FIG. 10 illustrates an embodiment for a HARQ feedback using a new DCI format during the UE PO;

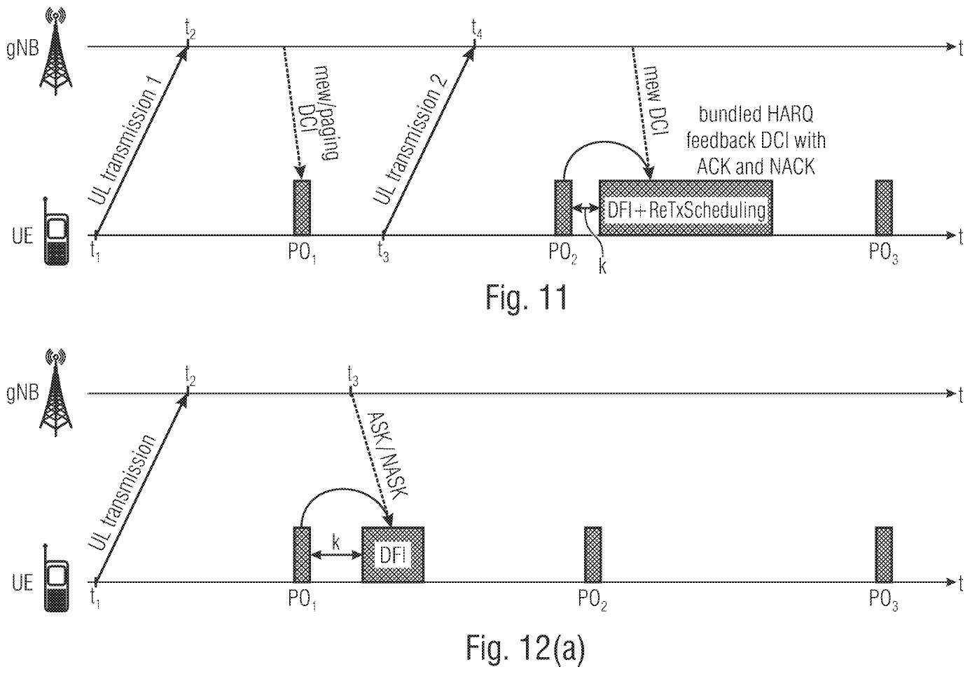

FIG. 11 illustrates an embodiment of a new DCI that includes, in case of a NACK, also scheduling information for a retransmission of the uplink transmission that is not successfully received at the gNB;

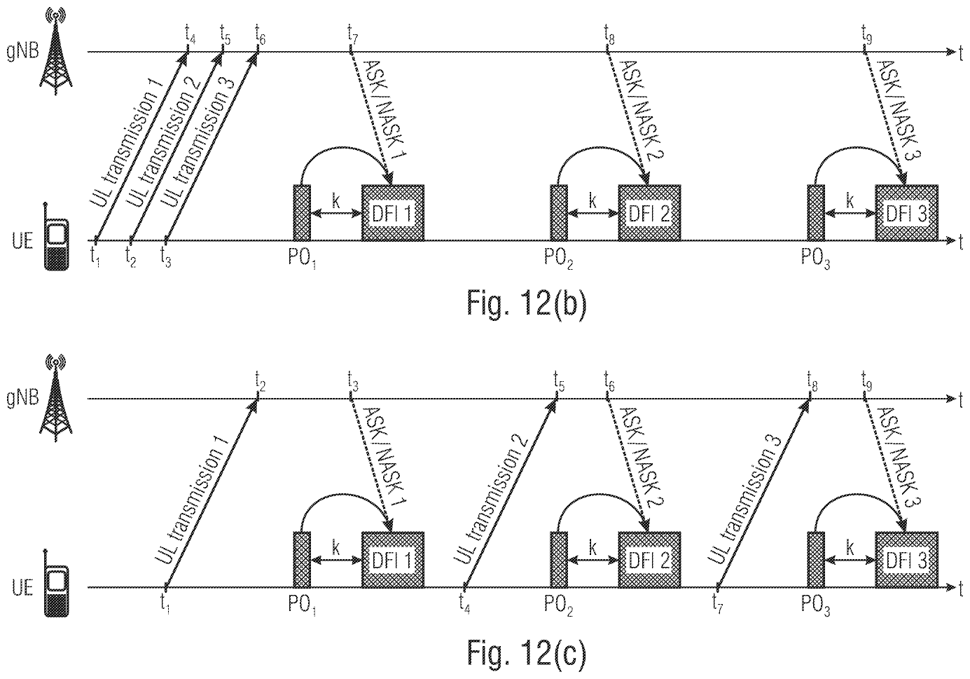

FIG. 12a-c illustrates embodiments indicating a message, like a DFI, including the explicit HARQ feedback for a single uplink transmission in a paging DCI or in a new DCI during a paging occasion;

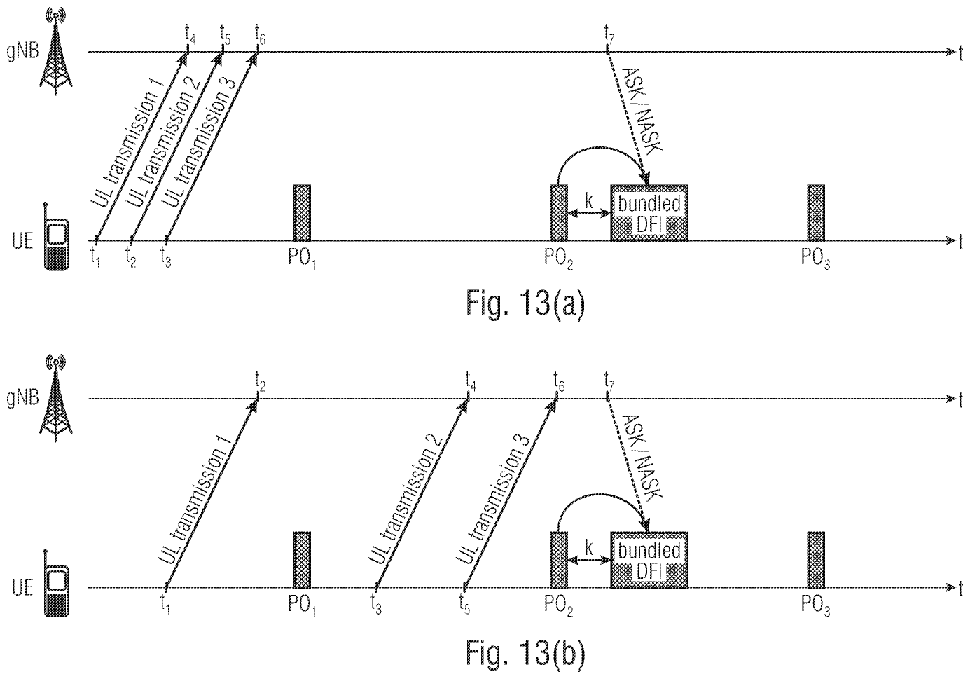

FIG. 13a-b illustrates embodiments for the indication of messages carrying the feedback, like a DFI indication, for a bundled feedback;

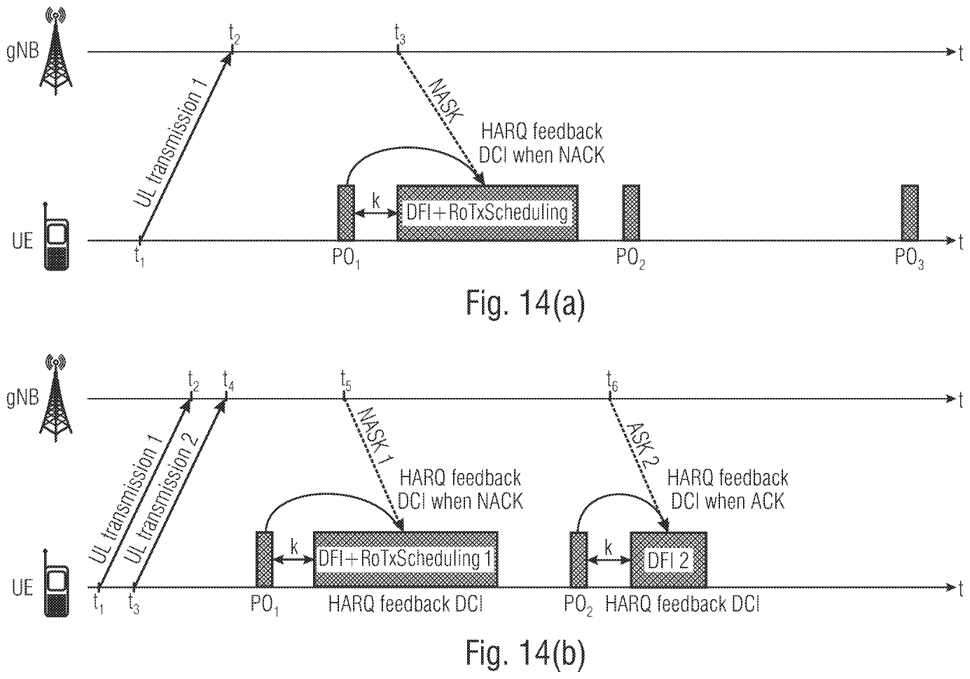

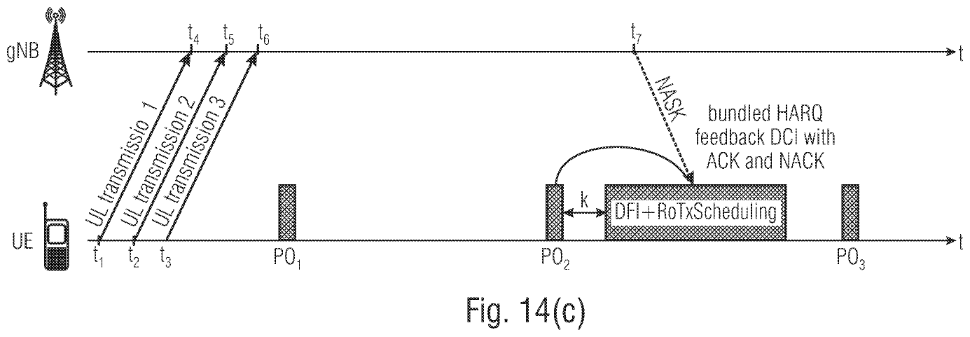

FIG. 14a-c illustrates embodiments using a HARQ feedback DCI including the DFI and the scheduling information which is indicated at the paging occasion using a paging DCI or a new DCI;

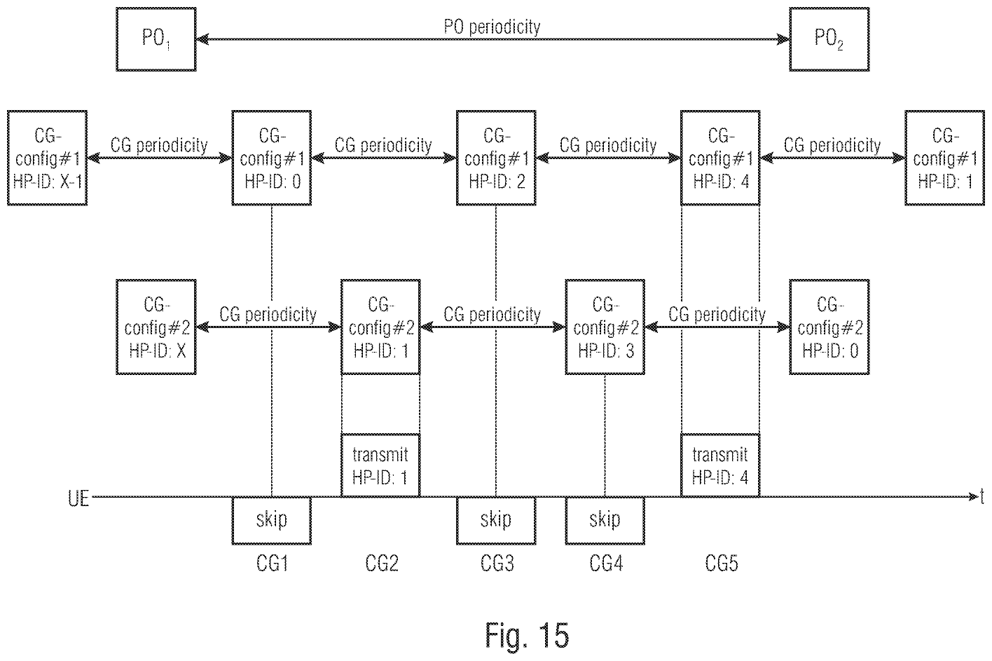

FIG. 15 illustrates an embodiment of a CG index-based derivation of HARQ process IDs in accordance with which a UE uses the HARQ process ID associated with the CG index used for a transmission;

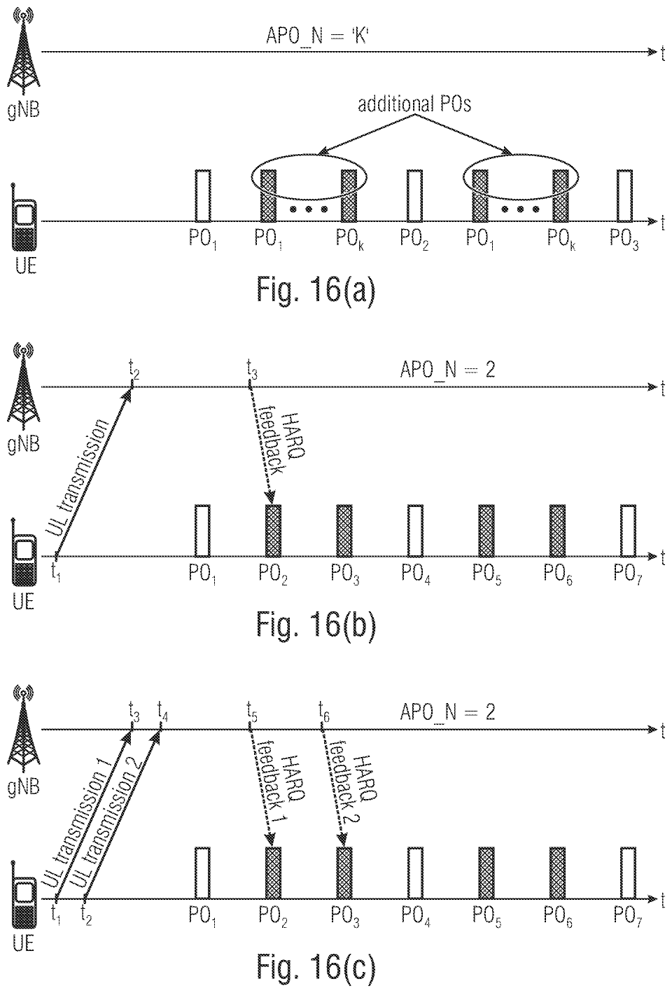

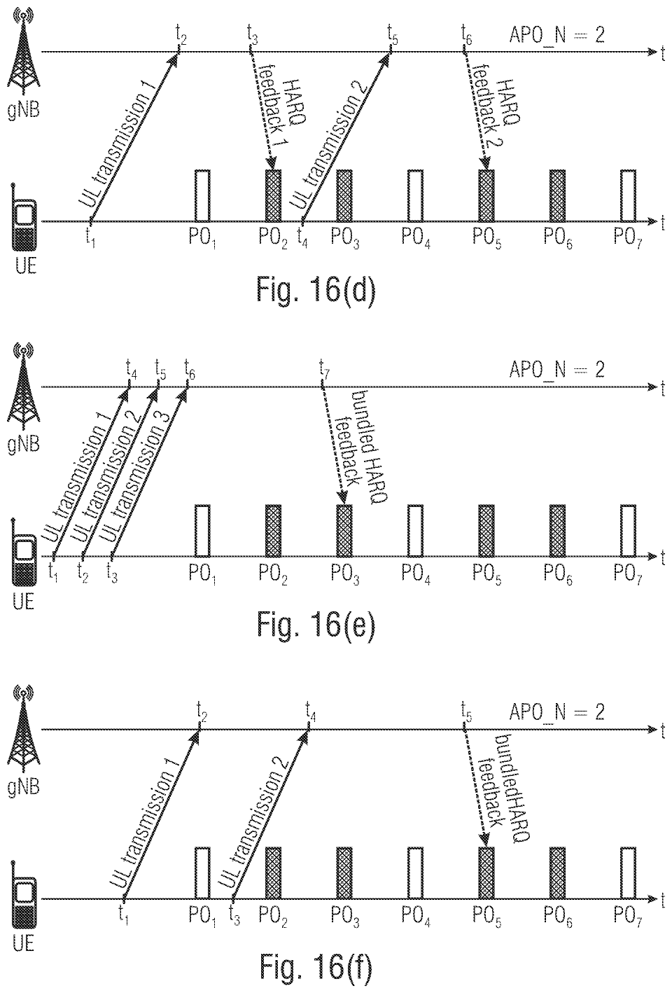

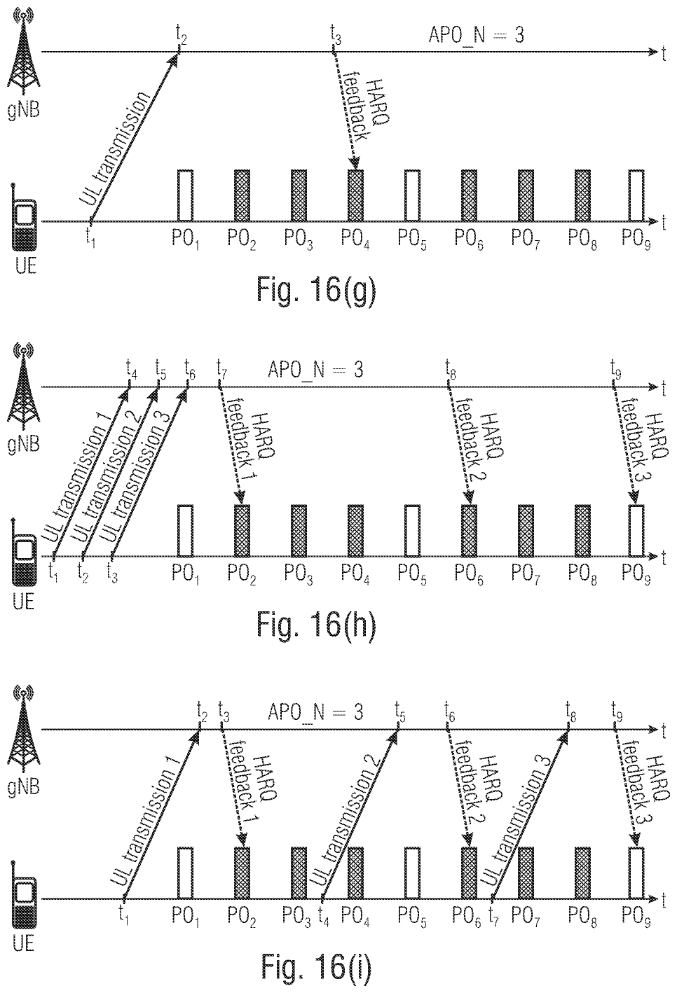

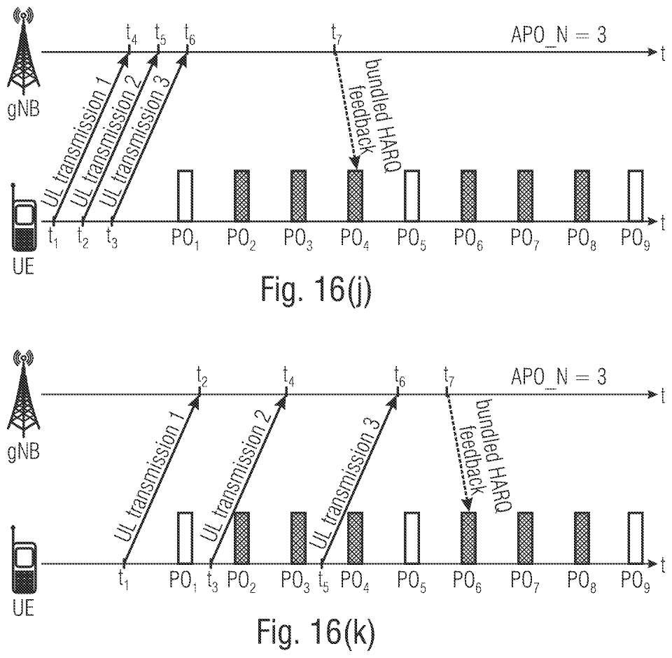

FIG. 16a-k illustrates embodiments of configured additional paging occasions for different values of the parameter APO_N with which the UE is configured or pre-configured;

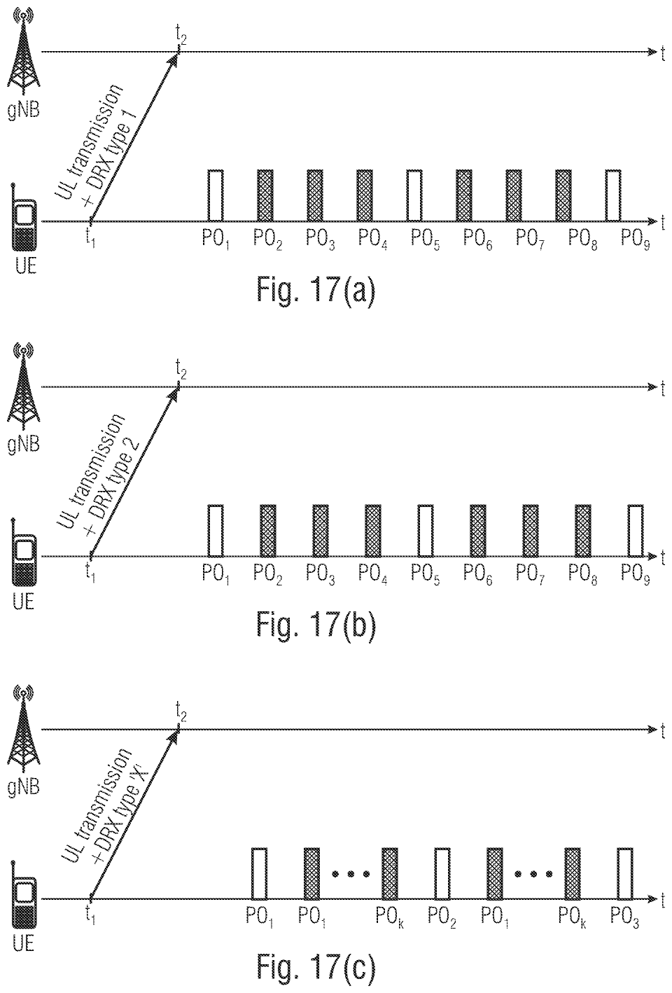

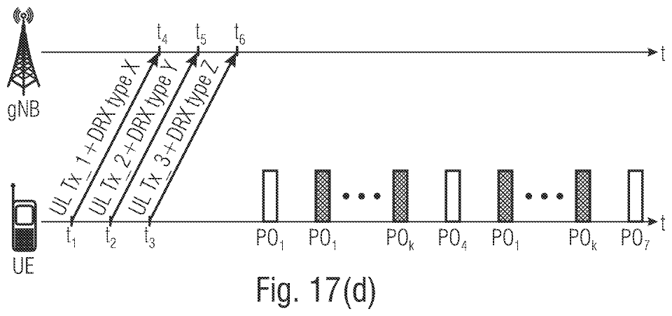

FIG. 17a-d illustrates embodiments for an implicit configuration of additional paging occasions responsive the indication of a DRX type together with an uplink transmission by the UE;

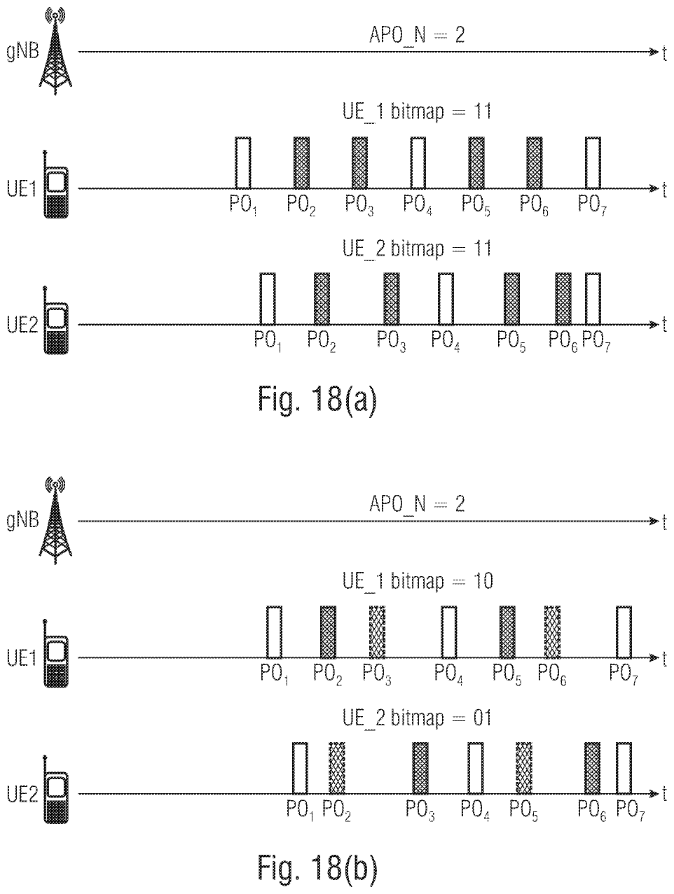

FIG. 18a-b illustrates embodiments of network configured additional paging occasions with APO_N=2 with different bitmap configurations;

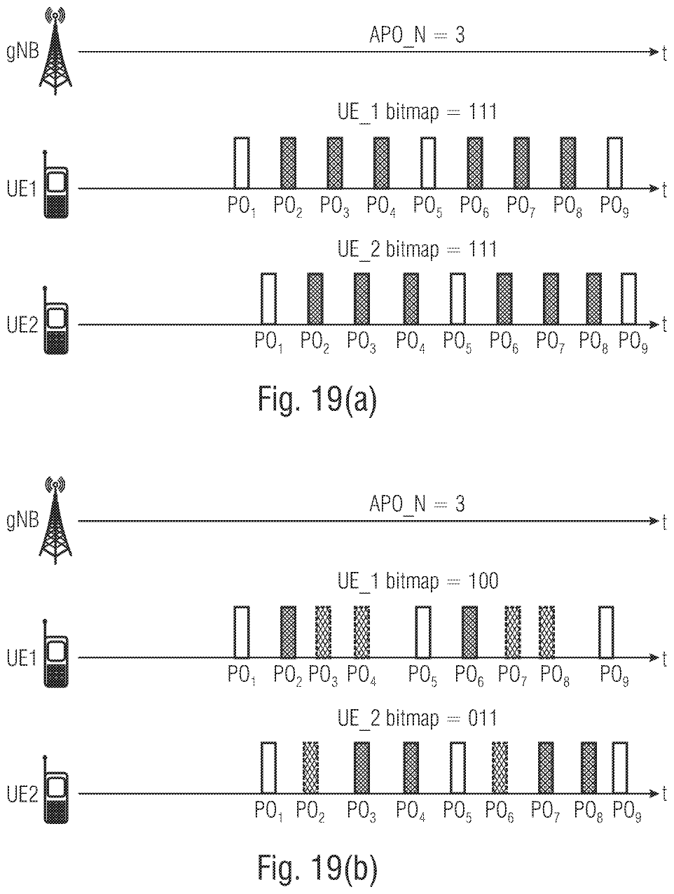

FIG. 19a-b illustrates other embodiments employing different bitmap configurations for a network configured number of additional paging occasions with APO_N=3;

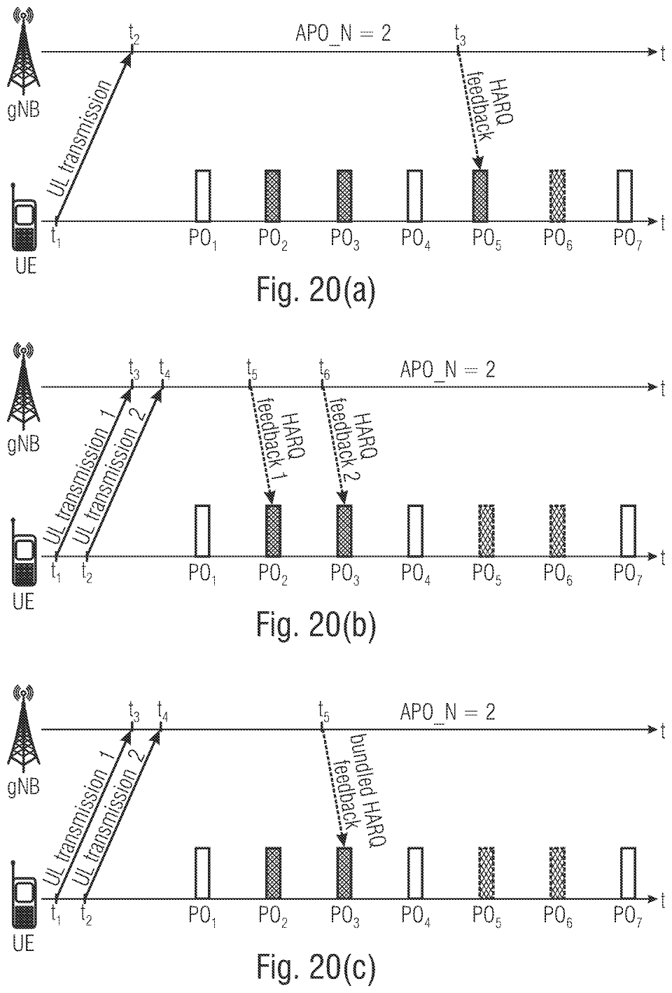

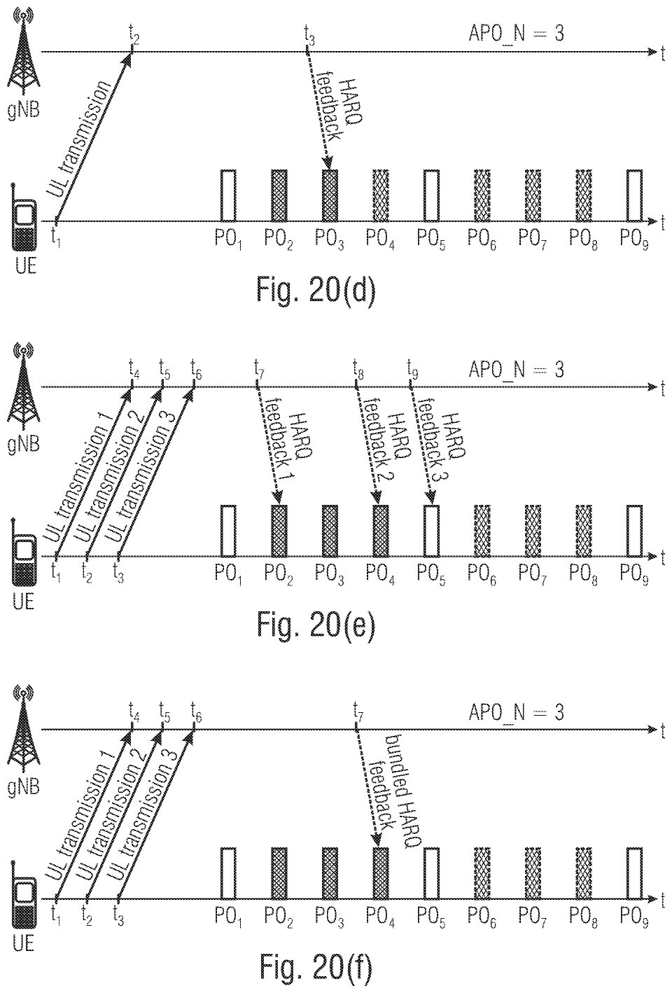

FIG. 20a-f illustrates embodiments of a UE stopping monitoring the additional paging occasions, once a HARQ feedback for an uplink transmission is received;

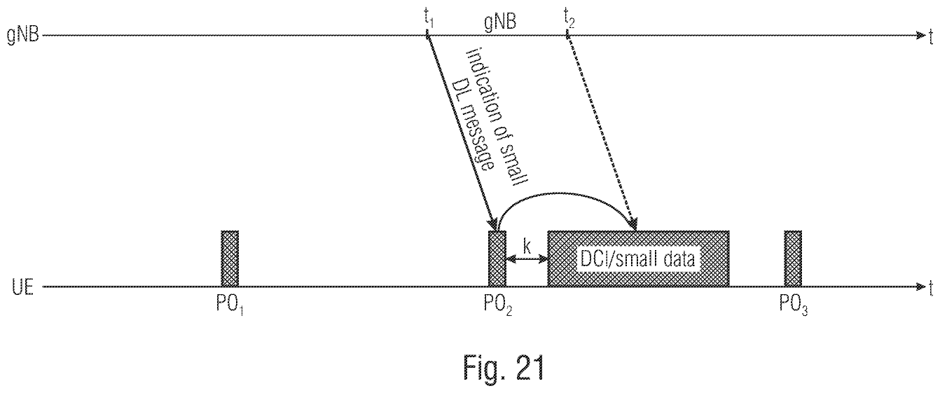

FIG. 21 illustrates an embodiment indicating the transmission of data, like small data, in a paging DCI; and

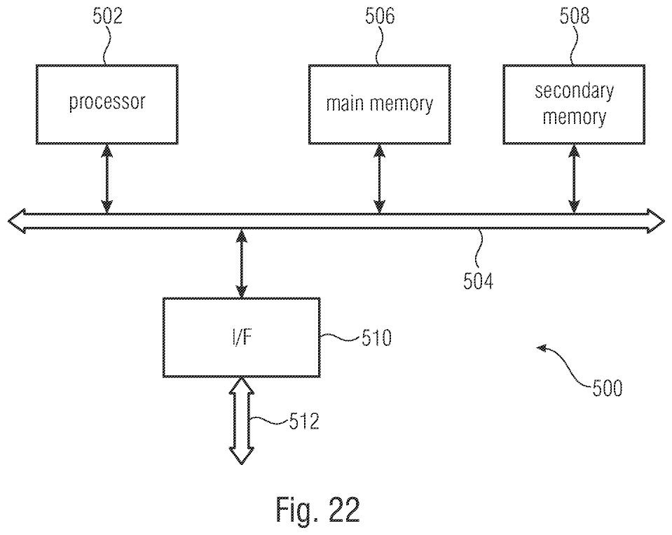

FIG. 22 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings in which the same or similar elements have the same reference signs assigned.

Conventionally, for a data transmission to a base station or gNB, a UE being in an inactive state, prior to the transmission transitions from inactive state, like the RRC_INACTIVE state or the RRC_IDLE state, to the RRC_CONNECTED state. FIG. 2 illustrates a conventional or legacy downlink transmission for data entailing a change of the RRC state of a UE. In FIG. 2, as is illustrated at \textcircled{1}, it is assumed that the UE is in an inactive state, like the RRC_INACTIVE state or the RRC_IDLE state. At regular intervals the UE monitors paging occasions for paging messages associated with the UE. Such paging messages are provided or transmitted by the network via the gNB and the paging messages are used for waking up UEs which are not in the connected mode. In FIG. 2, the gNB transmits \textcircled{2} a paging message for the UE, which is referred to as the valid paging message. The UE initiates \textcircled{3} the procedure for transitioning from the RRC_INACTIVE or RRC_IDLE state into the RRC_CONNECTED state \textcircled{4}. For example, the two-step or four-step RACH procedure may be employed together with an RRC_request or RRC_resume. Once the UE entered into the RRC_CONNECTED state the control information \textcircled{5}, like the DCI, for the data may be transmitted by the gNB for informing the UE about the specifics of the transmission of the data from the gNB to the UE. As may be seen from FIG. 2, the need for the UE to transition from the inactive state to the RRC_CONNECTED state entails substantial activity at the UE, thereby being expensive in terms of power efficiency. Also, additional messages need to be transmitted leading to the above signaling overhead.

In a wireless communication system or network, like the one described above with reference to FIG. 1, transmissions may be performed, which are referred to as a small data transmission, i.e., for transmissions in which the amount of data to be transmitted is below a certain threshold. There is currently no definition of small data size. For example, a transmission without a state change constitutes or is referred to a small data transmission, and a transmission for which the UE transitions to the connected state is no small data transmission. For such small data transmissions, the transition of the UE from an active state to the RRC_CONNECTED state may be expensive in terms of both power efficiency and signaling. Therefore, it is suggested to perform the transmission for the small data, both in the uplink, UL, direction and in the downlink, DL, direction, while the UE stays in the inactive state, like the RRC_INACTIVE state or the RRC_IDLE state, without transitioning to the RRC_CONNECTED state. For example, the MAG-A of the two-step random access preamble, RACH, procedure may be employed for UL transmissions, and the corresponding MSG-B of the two-step RACH procedure maybe employed for DL transmissions.

FIG. 3 illustrates an example for a DL transmission for small data without the UE changing the RRC state. In a similar way as in FIG. 2, also in FIG. 3, it is assumed that a UE is in the RRC_INACTIVE state or in the RRC_IDLE state \textcircled{1}. Responsive to a valid paging message \textcircled{2}, rather than transitioning from the RRC_INACTIVE state or from the RRC_IDLE state to the RRC_CONNECTED state, the UE expects, responsive to the valid paging message \textcircled{2} to receive from the gNB a control message \textcircled{3}, like a DCI, associated with the data to be transmitted from the gNB to the UE. On the basis of the information about the downlink transmission from the gNB to the UE the UE is able to monitor the respective resources for the actual downlink transmission of the data.

In case of an uplink transmission of small data, i.e., an uplink transmission of data for which the UE does not transition into the RRC_CONNECTED stage, the UE may employ configured grants, CGs, or pre-configured resources which may be another option to perform a transmission without a state transition, for providing resources that may be randomly utilized by the UE whenever there is data to be transmitted. The CGs avoid the package transmission delay for a scheduling request procedure and may increase the utilization ratio of allocated periodic radio resources. Different configured grant time domain resource allocation mechanisms exist in NR, referred to as type 1 CG and type 2 CG. A UE may be configured with CG(s) by RRC signaling at some time and the CG(s) may be periodically used by the UE. The UE configured with such CGs may employ such a configured grant in case small data is to be transmitted to the gNB in the uplink. FIG. 4 illustrates, schematically, an uplink transmission from the UE to the gNB without the UE changing its RRC state. The UE is assumed to be in the RRC_INACTIVE state or in the RRC_IDLE state \textcircled{1}, and, further, it is assumed that the UE has some data to be transmitted in the uplink to the gNB. The UE is configured with CGs. At CG \textcircled{2} uplink data is available, and the UE performs a UL transmission \textcircled{3} of this data to the gNB without transitioning to the RRC_CONNECTED state. As mentioned above, also pre-configured resources may be used for the transmission.

However, for the above described transmissions, either uplink or downlink, of so-called small data, for which the UE does not change its RRC state, an approach or mechanism is missing for providing feedback for such transmissions, like a hybrid automatic repeat request, hybrid ARQ or HARQ feedback.

The present invention provides improvements and enhancements in a wireless communication system or network addressing the above described problems, namely approaches for providing feedback for small data transmissions, e.g., for transmissions for which the UE does not change to the RRC_CONNECTED state. Embodiments of the present invention may be implemented in a wireless communication system as depicted in FIG. 1 including base stations and users, like mobile terminals or IoT devices. FIG. 5 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5/sidelink (SL) interface. When the UEs are not served by the base station, are not be connected to a base station, for example, they are not in an RRC connected state, or, more generally, when no SL resource allocation configuration or assistance is provided by a base station, the UEs may communicate with each other over the sidelink (SL). The system or network of FIG. 5, the one or more UEs 302, 304 of FIG. 5, and the base station 300 of FIG. 5 may operate in accordance with the inventive teachings described herein.

User Device

The present invention provides (see for example claim 1) a user device, UE, for a wireless communication system, the wireless communication system including one or more base stations,
wherein the UE is in an RRC_INACTIVE state or in an RRC_IDLE state and is to monitor one or more paging occasions,
wherein the UE is to perform one or more uplink, UL, transmissions to the base station without entering an RRC_CONNECTED state, e.g., using a configured grant, CG, or pre-configured resources,
wherein the UE is to monitor one or more paging occasions following the one or more UL transmissions for a message from the base station, the message being associated with feedback information, e.g., HARQ feedback formation, for the one or more UL transmissions.

In accordance with embodiments (see for example claim 2), the feedback information includes a feedback for a single UL transmission or a bundled feedback for a plurality of UL transmissions or a feedback for a number of HARQ processes.

In accordance with embodiments (see for example claim 3), the UE is to monitor a paging occasion not only for a paging-related message but also for a feedback related.

In accordance with embodiments (see for example claim 4), the message indicates a successful receipt, ACK, of the one or more UL transmissions at the base station and/or a non-successful receipt, NACK, of the one or more UL transmissions at the base station.

In accordance with embodiments (see for example claim 5), the message is a paging DCI, the paging DCI including the feedback information, e.g., by reusing bits of a short message field and/or reserved bits in the paging DCI.

In accordance with embodiments (see for example claim 6), the message is a new DCI different from a paging DCI, the new DCI including the feedback information, and, optionally, scheduling information for a retransmission.

In accordance with embodiments (see for example claim 7), the new DCI has the same length as the paging DCI but includes additional information, like an additional information element, IE, having one or more bits for differentiating the new DCI and the paging DCI, or the included CRC is scrambled with a another RNTI than the P-RNTI, or has a different length as the paging DCI.

In accordance with embodiments (see for example claim 8), the feedback information includes a plurality of bits, wherein one of the bits indicates the successful receipt, ACK, of the one or more UL transmissions or the non-successful receipt, NACK, of the one or more UL transmissions.

In accordance with embodiments (see for example claim 9), the remaining bits may indicate a feedback process, like the HARQ process, associated with the feedback, and/or a New Data Indicator, NDI, and, optionally, in case of a NACK, scheduling information for a retransmission.

In accordance with embodiments (see for example claim 10),
the feedback information one bit to indicate the successful receipt, ACK, of the UL transmission or the non-successful receipt, NACK, of a plurality of UL transmissions, the NACK being used in case one or more or all of the plurality of UL transmissions are non-successful, and
responsive to the NACK, the UE is to obtain a predefined message including for the plurality of UL transmissions the detailed feedback, e.g., by searching for a different DCI format in a predefined search space, like the CORESET #0.

In accordance with embodiments (see for example claim 11), in case the feedback information includes scheduling information for a retransmission one or more of the following is indicated:
a time factor indicating when to perform the retransmission with respect to the paging occasion at which the message is received,
a frequency offset with respect to a reference frequency,
an exact time/frequency allocation of the retransmission.

In accordance with embodiments (see for example claim 12),
the UE is to determine a successful receipt, ACK, of the one or more UL transmissions at the base station when the message is of a first type, and
the UE is to determine a non-successful receipt, NACK, of the one or more UL transmissions at the base station and, optionally, scheduling information for a retransmission, when the message is of a second type.

In accordance with embodiments (see for example claim 13), the message of the first type is a default paging DCI including feedback indicating a successful receipt, ACK, and the message of the second type is a new DCI different from a paging DCI, the new DCI including feedback indicating a non-successful receipt, NACK, and, optionally, scheduling information for a retransmission.

In accordance with embodiments (see for example claim 14), the message of the first type is a default paging DCI including no feedback, and the message of the second type is a new DCI different from a paging DCI, the new DCI not including feedback, but, optionally, scheduling information for a retransmission, wherein both the paging DCI and the new DCI include identification information associating the UL transmission with a single and/or bundled feedback.

In accordance with embodiments (see for example claim 15), the new DCI has the same length as the paging DCI but includes additional information, like an additional information element, IE, having one or more bits for differentiating the new DCI and the paging DCI, or the included CRC is scrambled with a another RNTI than the P-RNTI, or has a different length as the paging DCI.

In accordance with embodiments (see for example claim 16), in case the feedback information includes scheduling information for a retransmission one or more of the following is indicated:
a time factor indicating when to perform the retransmission with respect to the paging occasion at which the message is received,
a frequency offset with respect to a reference frequency,
an exact time/frequency allocation of the retransmission.

In accordance with embodiments (see for example claim 17),
the message indicates that feedback is available for the one or more UL transmissions, and
the UE, responsive to the message, monitors a configured or pre-configured set of resources for a further message, like a DFI, the further message indicating a successful receipt, ACK, of the one or more UL transmissions at the base station and/or a non-successful receipt, NACK, of the one or more UL transmissions at the base station, and, optionally, scheduling information for a retransmission.

In accordance with embodiments (see for example claim 18),
the message indicates a set of resources for a further message, like a DFI, the further message indicating a successful receipt, ACK, of the one or more UL transmissions at the base station and/or a non-successful receipt, NACK, of the one or more UL transmissions at the base station, and, optionally, scheduling information for a retransmission, and
the UE, responsive to the message, monitors the indicated set of resources for the further message.

In accordance with embodiments (see for example claim 19), the message indicates one or more of the following:
a time factor indicating when to expect the further message with respect to the paging occasion at which the message is received,
a frequency offset with respect to a reference frequency,
an exact time/frequency allocation of the further message,
an information element, IE, indicating either a single or bundled feedback.

In accordance with embodiments (see for example claim 20), the message is
a paging DCI, the paging DCI including an indication that the configured or pre-configured set of resources is to be monitored for the further message, or the set of resources to be monitored for the further message, e.g., by reusing bits of a short message field and/or reserved bits in the paging DCI, or
a new DCI different from a paging DCI, the new DCI including the set of resources for the further message.

In accordance with embodiments (see for example claim 21), the new DCI has the same length as the paging DCI but includes additional information, like an additional information element, IE, having one or more bits for differentiating the new DCI and the paging DCI, or the included CRC is scrambled with a another RNTI than the P-RNTI, or has a different length as the paging DCI.

In accordance with embodiments (see for example claim 22), the UE is to monitor the message only in case the UE performs a transmission in a period previous to the paging occasion.

In accordance with embodiments (see for example claim 23),
the UE is to perform the uplink, UL, transmission to the base station using configured grants, CGs, or pre-configured resources,
wherein respective feedback processes, like the HARQ processes, associated with the feedback for UL transmissions during a paging occasion periodicity, are determined based on timing information for the configured grants or the pre-configured resources used for an UL transmission during the paging occasion periodicity, such as a slot number, a frame number or an index of the configured grant, or the pre-configured resources.

In accordance with embodiments (see for example claim 24), following the one or more UL transmissions, the UE is to monitor one or more additional paging occasions for the message from the base station.

The present invention provides (see for example claim 25) a user device, UE, for a wireless communication system, the wireless communication system including one or more base stations,
wherein the UE is in an RRC_INACTIVE state or in an RRC_IDLE state and is to monitor one or more paging occasions,
wherein the UE is to perform an uplink, UL, transmission to the base station without entering an RRC_CONNECTED state, e.g., using a configured grant, CG, or pre-configured resources,
wherein the UE is to monitor one or more additional paging occasions following the one or more UL transmissions for a message from the base station, the message being associated with feedback information, e.g., HARQ feedback formation, for the one or more UL transmissions.

In accordance with embodiments (see for example claim 26), the one or more additional paging occasions are between adjacent default paging occasions.

In accordance with embodiments (see for example claim 27), the UE is to receive from the base station the one or more additional paging occasions, e.g. using a control message, like a RRC or Downlink Control Information, DCI, message, wherein the number of additional paging occasions may be dynamic/fixed/semi-static in time.

In accordance with embodiments (see for example claim 28), the UE is configured with a DRX cycle covering the additional paging occasions.

In accordance with embodiments (see for example claim 29),
the UE is to employ a certain monitoring duration, like a certain DRX cycle, between adjacent default paging occasions to monitor for the message from the base station, the certain monitoring duration selected from one or more configured monitoring durations, and
during the one or more UL transmissions, the UE is to signal to the base station the certain monitoring duration so as to allow the base station to transmit the message at the one or more additional paging occasions.

In accordance with embodiments (see for example claim 30), in case the UE does not signal to the base station any certain monitoring duration, the UE is to only monitor the default paging occasions for the message.

In accordance with embodiments (see for example claim 31), the UE is configured by the base station semi-statically, e.g., in an RRC message, or dynamically, e.g., in a DCI, with a subset of the additional paging occasions to be monitored for the message, e.g., using a bitmap indicating among the additional paging occasions those to be used by the UE and those not to be used by the UE.

In accordance with embodiments (see for example claim 32), the UE is to stop monitoring the additional paging occasions once the UE received the feedback for the one or more UL transmissions, and is to return to monitoring the default paging occasions.

The present invention provides (see for example claim 33) a user device, UE, for a wireless communication system, the wireless communication system including one or more base stations,
wherein the UE is in an RRC_INACTIVE state or in an RRC_IDLE state and is to monitor one or more paging occasions,
wherein the UE is to receive one or more downlink, DL, transmissions from the base station without entering an RRC_CONNECTED state,
wherein the UE is to monitor one or more paging occasions for a message from the base station, the message
including a downlink, DL, transmission from the base station downlink, or
indicating that a configured or pre-configured set of resources is to be monitored for a further message, or indication a set of resources for a further message including a downlink, DL, transmission from the base station downlink.

In accordance with embodiments (see for example claim 34), the message indicates one or more of the following:
a time factor indicating when to expect the further message with respect to the paging occasion at which the message is received,
a frequency offset with respect to a reference frequency,
an exact time/frequency allocation of the further message.

In accordance with embodiments (see for example claim 35), the message is
a paging DCI, the paging DCI including the downlink, DL, transmission or the set of resources for the further message, e.g., by reusing bits of a short message field and/or reserved bits in the paging DCI, or
a new DCI different from a paging DCI, the new DCI including the downlink, DL, transmission or the set of resources for the further message.

In accordance with embodiments (see for example claim 36), the new DCI has the same length as the paging DCI but includes additional information, like an additional information element, IE, having one or more bits for differentiating the new DCI and the paging DCI, or the included CRC is scrambled with a another RNTI than the P-RNTI, or has a different length as the paging DCI.

In accordance with embodiments (see for example claim 37), the message is scrambled using a dedicated RNTI being different from an RNTI for a default paging message.

In accordance with embodiments (see for example claim 38), the UE is to receive the dedicated RNTI in an RRC message to be valid semi-statically in time, and/or in a DCI.

In accordance with embodiments (see for example claim 39), the UE is to signal the RNTI it wants to use as a part of the UL transmission, like in addition to the DRX cycle.

In accordance with embodiments (see for example claim 40), the UE comprise one or more of a mobile terminal, or stationary terminal, or cellular IoT-UE, or vehicular UE, or vehicular group leader (GL) UE, or an IoT or narrowband IoT, NB-IoT, device, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

Base Station

The present invention provides (see for example claim 41) a base station, BS, for a wireless communication system,
wherein the BS is to receive one or more uplink, UL, transmissions from a user device, UE, the UE being in an RRC_INACTIVE state or in an RRC_IDLE state and not entering an RRC_CONNECTED state for the transmission, and
wherein, following the one or more UL transmissions, the BS is to transmit a message to the UE at one or more paging occasions monitored by the UE, the message being associated with feedback information, e.g., HARQ feedback formation, for the one or more UL transmissions.

In accordance with embodiments (see for example claim 42), the feedback information includes a feedback for a single UL transmission or a bundled feedback for a plurality of UL transmissions or a feedback for a number of HARQ processes regardless of the number of actually performed UL transmissions in the related period.

In accordance with embodiments (see for example claim 43), the BS is not to transmit the message, in case there is a paging of the UE from the radio access network or from the core network at the paging occasion, or in case there is a data transmission or reception at the paging occasion.

In accordance with embodiments (see for example claim 44), the message indicates a successful receipt, ACK, of the one or more UL transmissions at the base station and/or a non-successful receipt, NACK, of the one or more UL transmissions at the base station.

In accordance with embodiments (see for example claim 45), the message is a paging DCI, the paging DCI including the feedback information, e.g., by reusing bits of a short message field and/or reserved bits in the paging DCI.

In accordance with embodiments (see for example claim 46),
the message is a new DCI different from a paging DCI, the new DCI including the feedback information, and
wherein, for differentiating the new DCI and the paging DCI, the new DCI has the same length as the paging DCI but includes additional information, like an additional information element, IE, having one or more bits, or has a different length as the paging DCI.

In accordance with embodiments (see for example claim 47), the feedback information includes a plurality of bits, wherein one of the bits indicates the successful receipt, ACK, of the one or more UL transmissions or the non-successful receipt, NACK, of the one or more UL transmissions, and wherein the remaining bits may indicate a feedback process, like the HARQ process, associated with the feedback,

In accordance with embodiments (see for example claim 48),
the feedback information one bit to indicate the successful receipt, ACK, of the UL transmission or the non-successful receipt, NACK, of a plurality of UL transmissions, the NACK being used in case one or more or all of the plurality of UL transmissions are non-successful, and
responsive to the NACK, the UE is to obtain a predefined message including for the plurality of UL transmissions the detailed feedback, e.g., by searching for a different DCI format in a predefined search space, like the CORESET #0.

In accordance with embodiments (see for example claim 49),
the BS is to signal a successful receipt, ACK, of the one or more UL transmissions at the base station by sending a first type the message, and
the BS is to signal a non-successful receipt, NACK, of the one or more UL transmissions at the base station by sending a second type of the message.

In accordance with embodiments (see for example claim 50), the message of the first type is a default paging DCI not including any feedback related information, and the message of the second type is a new DCI different from a paging DCI, the new DCI including the feedback information.

In accordance with embodiments, for differentiating the new DCI and the default paging DCI, the new DCI has the same length as the default paging DCI but includes additional information, like an additional information element, IE, having one or more bits, or has a different length as the default paging DCI.

In accordance with embodiments (see for example claim 51), the message indicates that feedback is available for the one or more UL transmissions at a configured or pre-configured set of resources for a further message, like a DFI, the further message indicating a successful receipt, ACK, of the one or more UL transmissions at the base station and/or a non-successful receipt, NACK, of the one or more UL transmissions at the base station, and, optionally, scheduling information for a retransmission.

In accordance with embodiments (see for example claim 52), the message indicates a set of resources for a further message, like a DFI, the further message indicating a successful receipt, ACK, of the one or more UL transmissions at the base station and/or a non-successful receipt, NACK, of the one or more UL transmissions at the base station, and, optionally, scheduling information for a retransmission.

In accordance with embodiments (see for example claim 53), the message indicates one or more of the following:
a time factor indicating when to expect the further message with respect to the paging occasion at which the message is received,
a frequency offset with respect to a reference frequency,
an exact time/frequency allocation of the further message,
an information element, IE, indicating either a single or bundled feedback.

In accordance with embodiments (see for example claim 54), the message is
a paging DCI, the paging DCI including the set of resources for the further message, e.g., by reusing bits of a short message field and/or reserved bits in the paging DCI, or
a new DCI different from a paging DCI, the new DCI including the set of resources for the further message, wherein, for differentiating the new DCI and the paging DCI, the new DCI has the same length as the paging DCI but includes additional information, like an additional information element, IE, having one or more bits, or has a different length as the paging DCI.

In accordance with embodiments (see for example claim 55), following the one or more UL transmissions, the BS is to send the message on one or more additional paging occasions.

The present invention provides (see for example claim 56) a base station, BS, for a wireless communication system,
wherein the BS is to receive one or more uplink, UL, transmissions from a user device, UE, the UE being in an RRC_INACTIVE state or in an RRC_IDLE state and not entering an RRC_CONNECTED state for the transmission, and
wherein, following the one or more UL transmissions, the BS is to transmit a message to the UE at one or more additional paging occasions monitored by the UE, the message being associated with feedback information, e.g., HARQ feedback formation, for the one or more UL transmissions.

In accordance with embodiments (see for example claim 57), the one or more additional paging occasions are between adjacent default paging occasions.

In accordance with embodiments (see for example claim 58), the BS is to signal to the UE the one or more additional paging occasions, e.g. using a control message, like a RRC or Downlink Control Information, DCI, message, wherein the number of additional paging occasions may be dynamic/fixed/semi-static in time.

In accordance with embodiments (see for example claim 59),
during the one or more UL transmissions, the BS is to signal to the base station a certain monitoring duration employed by the UE, like a certain DRX cycle, between adjacent default paging occasions to monitor for the message from the base station, the certain monitoring duration selected from one or more configured monitoring durations, and
the BS is to transmit the message at the one or more additional paging occasions being between adjacent default paging occasions.

In accordance with embodiments (see for example claim 60), in case the BS does not receive a signaling of any certain monitoring duration, the BE is to transmit the message on the default paging occasions.

In accordance with embodiments (see for example claim 61), the BS is to configure the UE semi-statically, e.g., in an RRC message, or dynamically, e.g., in a DCI, with a subset of the additional paging occasions to be monitored for the message, e.g., using a bitmap indicating among the additional paging occasions those to be used by the UE and those not to be used by the UE.

The present invention provides (see for example claim 62) a base station, BS, for a wireless communication system,
wherein the BS is to transmit one or more downlink, DL, transmissions to a user device, UE, the UE being in an RRC_INACTIVE state or in an RRC_IDLE state and not entering an RRC_CONNECTED state for the transmission, and
wherein the BS is to transmit a message to the UE at one or more paging occasions monitored by the UE, the message
including the downlink, DL, transmission from the base station downlink, or
indicating a set of resources for a further message, like a DFI, including a downlink, DL, transmission from the base station downlink.

In accordance with embodiments (see for example claim 63), the message indicates one or more of the following:
a time factor indicating when to expect the further message with respect to the paging occasion at which the message is received,
a frequency offset with respect to a reference frequency,
an exact time/frequency allocation of the further message.

In accordance with embodiments (see for example claim 64), the message is

a paging DCI, the paging DCI including the downlink, DL, transmission or the set of resources for the further message, e.g., by reusing bits of a short message field and/or reserved bits in the paging DCI, or

a new DCI different from a paging DCI, the new DCI including the downlink, DL, transmission or the set of resources for the further message, wherein, for differentiating the new DCI and the paging DCI, the new DCI has the same length as the paging DCI but includes additional information, like an additional information element, IE, having one or more bits, or has a different length as the paging DCI.

In accordance with embodiments (see for example claim 65), the message is scrambled using a dedicated RNTI being different from an RNTI for a default paging message.

In accordance with embodiments (see for example claim 66), the base station comprises one or more of a macro cell base station, or a small cell base station, or a central unit of a base station, or a distributed unit of a base station, or a road side unit (RSU), or a UE, or a group leader (GL), or a relay, or a remote radio head, or an AMF, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

System

The present invention provides (see for example claim 67) a wireless communication system, comprising an inventive user device, UE, and/or an inventive base station, BS.

Methods

The present invention provides (see for example claim 68) a method for a wireless communication system, the wireless communication system including one or more base stations, and a user device, UE, being in an RRC_INACTIVE state or in an RRC_IDLE state, the method comprising:
monitoring, by the UE, one or more paging occasions,
performing, by the UE, one or more uplink, UL, transmissions to the base station without entering an RRC_CONNECTED state, e.g., using a configured grant, CG, or pre-configured resources,
monitoring, by the UE, one or more paging occasions following the one or more UL transmissions for a message from the base station, the message being associated with feedback information, e.g., HARQ feedback formation, for the one or more UL transmissions.

The present invention provides (see for example claim 69) a method for a wireless communication system, the wireless communication system including one or more base stations, and a user device, UE, being in an RRC_INACTIVE state or in an RRC_IDLE state, the method comprising:
monitoring, by the UE, one or more paging occasions,
performing, by the UE, an uplink, UL, transmission to the base station without entering an RRC_CONNECTED state, e.g., using a configured grant, CG, or pre-configured resources,
monitoring, by the UE, one or more additional paging occasions following the one or more UL transmissions for a message from the base station, the message being associated with feedback information, e.g., HARQ feedback formation, for the one or more UL transmissions.

The present invention provides (see for example claim 70) a method for a wireless communication system, the wireless communication system including one or more base stations, and a user device, UE, being in an RRC_INACTIVE state or in an RRC_IDLE state, the method comprising:
monitoring, by the UE, one or more paging occasions,
receiving, by the UE, one or more downlink, DL, transmissions from the base station without entering an RRC_CONNECTED state,
monitoring, by the UE, one or more paging occasions for a message from the base station, the message
including a downlink, DL, transmission from the base station downlink, or
indicating that a configured or pre-configured set of resources is to be monitored for a further message, or indication a set of resources for a further message including a downlink, DL, transmission from the base station downlink.

The present invention provides (see for example claim 71) a method for a wireless communication system, the wireless communication system including one or more base stations and a user device, the method comprising:
receiving, by the BS, one or more uplink, UL, transmissions from the user device, UE, the UE being in an RRC_INACTIVE state or in an RRC_IDLE state and not entering an RRC_CONNECTED state for the transmission, and
following the one or more UL transmissions, transmitting, by the BS, a message to the UE at one or more paging occasions monitored by the UE, the message being associated with feedback information, e.g., HARQ feedback formation, for the one or more UL transmissions.
The present invention provides (see for example claim 72. A method A base station, BS, for a wireless communication system, the wireless communication system including one or more base stations and a user device, the method comprising:
receiving, by the BS, one or more uplink, UL, transmissions from a user device, UE, the UE being in an RRC_INACTIVE state or in an RRC_IDLE state and not entering an RRC_CONNECTED state for the transmission, and
following the one or more UL transmissions, transmitting, by the BS, a message to the UE at one or more additional paging occasions monitored by the UE, the message being associated with feedback information, e.g., HARQ feedback formation, for the one or more UL transmissions.

The present invention provides (see for example claim 73) a method for a wireless communication system, the wireless communication system including one or more base stations and a user device, the method comprising:
transmitting, by the BS, one or more downlink, DL, transmissions to the user device, UE, the UE being in an RRC_INACTIVE state or in an RRC_IDLE state and not entering an RRC_CONNECTED state for the transmission, and
transmitting, by the BS, a message to the UE at one or more paging occasions monitored by the UE, the message
including the downlink, DL, transmission from the base station downlink, or
indicating a set of resources for a further message, like a DFI, including a downlink, DL, transmission from the base station downlink.

Computer Program Product

Embodiments of the present invention provide a computer program product comprising instructions which, when the program is executed by a computer, causes the computer to carry out one or more methods in accordance with the present invention.

Embodiments of the present invention provide various approaches or aspects for providing feedback, like a HARQ feedback, for a transmission of small data for which the UE does not change its RRC state.

HARQ Feedback in the Paging Occasions (POs)

The current 3GPP Rel-15/Rel-16 specification defines the paging information to carry information elements, IEs, which are shown in the Table 1 below, in the DCI format 1_0 with a cyclic redundancy check, CRC, scrambled by the paging radio network temporary identifier, P-RNTI.

TABLE 1
DCI Format 1_0 scrambled by P-RNTI

| | |
|---|---|
| Short Messages Indicator | 2 bits |
| Short Messages | 8 bits |
| Frequency Domain Resource | ┌log₂(N_{RB}^{DL, BWP}(N_{RB}^{DL, BWP} + 1)/2┐ bits |
| Assignment | N_{RB}^{DL, BWP} is the size of CORESET 0 |
| Time Domain Resource | 4 bits |
| Assignment | |
| VRB-PRB mapping | 1 bit |
| MCS | 5 bits |
| TB scaling | 2 bits |
| Reserved | 6 bits |

In the DCI shown in the Table 1 above, the short messages is an 8 Bit IE indicating either a modification in the system information or an ETWS, earthquake and tsunami warning system, primary notification depending whether the bit corresponding to the most significant bit, MSB, or the one next to the MSB is set to \textcircled{1}. The other bits are not in use and, when received by the UE, are ignored. The DCI scrambled with the P-RNTI may also be referred to as the paging DCI that is transmitted during a paging occasion, PO, for the UE, for example in case there is a paging from the radio access network, RAN, in case the UE is in the RRC_INACTIVE state, or in case there is a paging from both the RAN and the core network, CN, when the UE is in the RRC_IDLE state. The transmission of the above DCI also occurs when there is a short message transmission. The UE is also configured with an I-RNTI, inactive-RNTI, which is used to identify the UE context in the RRC_INACTIVE state in NR when being connected to the 5G core network, 5GC.

In accordance with embodiments of the present invention, the feedback, like a HARQ feedback, for a transmission, like a UL transmission from the UE to the gNB, is transmitted during the paging occasion of the UE. FIG. 6 illustrates an embodiment for a HARQ feedback in a paging DCI during a UE paging occasion, PO. The UE is in the RRC_INACTIVE state or in the RRC_IDLE state and monitors paging occasions PO₁ to PO₃ for paging messages of the UE. The UE, at a time t1 performs an uplink transmission \textcircled{1} to the gNB, for example using configured grants or pre-configured resources in a way as described above with reference to FIG. 4. The gNB receives the uplink transmission \textcircled{1} at a time t2 and, after processing the received uplink transmission, at a time t3, transmits a feedback \textcircled{2}, like a HARQ feedback in the paging DCI at or during the paging occasion PO₁. The HARQ feedback indicates a successful and/or non-successful reception of the uplink transmission \textcircled{1} at the gNB. In accordance with the embodiment described with reference to FIG. 6, the short message bits and/or the reserved bits in the paging DCI indicated in the Table 1 above may be employed to transmit the HARQ feedback information for the corresponding transmission in the uplink during a paging occasion. In accordance with embodiments, in case a HARQ feedback is to be transmitted from the gNB to the UE and when using the reserved bits of the above paging DCI, the paging DCI may also be transmitted during one or more paging occasions even in case there is no paging from the RAN or the RAN/CN or in case there is no transmission of a short message using a paging DCI at the respective POs. In other words, the UE also monitors those paging occasions for feedback or HARQ related DCIs during which no short message for the UE is transmitted or during which no paging from the RAN/CN occurs for the UE.

For example, when considering the current specifications, the MSB or the bit corresponding to the right of the MSB indicates the “systemInfoModification” and the “etwsAndCmasIndication” respectively. Therefore, a total of six bits are currently unused in the DCI depicted in the Table 1 above and, therefore, in accordance with embodiment these bits are reused to indicate the HARQ feedback. In accordance with other embodiments, instead of the just mentioned unused bits, also the reserved bits of the paging DCI may be employed to indicate the HARQ feedback. For example, out of the six bits, the use of one bit may signal the result of the feedback, for example a successful reception of the transmission at the gNB, like an acknowledgement, ACK, or a non-successful reception at the gNB, like a non-acknowledgement, NACK. The other five bits may be used to signal a corresponding HARQ process for the result. For example, in case that a number of HARQ processes is configured, the gNB may always reports for all of them regardless of whether there was an UL transmission associated with all of these HARQ processes or not.

FIG. 7 illustrates other embodiments for a feedback in the paging DCI during the UE PO for each of a plurality of uplink transmissions from the UE to the gNB. FIG. 7(a) illustrates a UE being in the RRC_INACTIVE state or in the RRC_IDLE state and that transmits, for example, at times t1, t2 and t3 using, for example, respective configured grants or pre-configured resources, uplink transmissions \textcircled{1}, \textcircled{2} and \textcircled{3} to the gNB that receives the first uplink transmission \textcircled{1} at time t4, the second uplink transmission \textcircled{2} at time t5 and the third uplink transmission \textcircled{3} at time t6. For each of the uplink transmissions the gNB provides feedback, namely HARQ feedback \textcircled{1}, HARQ feedback \textcircled{2} and HARQ feedback \textcircled{3}. In the embodiment depicted in FIG. 7(a), all uplink transmissions occur before the first paging occasion PO₁. The gNB transmits the feedback for the respective uplink transmissions in separate paging DCIs, and the HARQ feedback \textcircled{1} for the first uplink transmission is transmitted in the paging DCI at paging occasion PO₁, the second HARQ feedback \textcircled{2} for the second uplink transmission is transmitted at the next paging occasion PO₂ in the paging DCI, and the HARQ feedback \textcircled{3} for the third uplink transmission is transmitted at the third paging occasion PO₃.

FIG. 7(b) shows another embodiment for transmitting HARQ feedback in a paging DCI for a plurality of uplink transmissions. The UE is in the RRC_INACTIVE state or in the RRC_IDLE state and performs three uplink transmissions to the gNB. Other than in FIG. 7(a), the first uplink transmission \textcircled{1} occurs at a time t1 before the first paging occasion PO₁ and is received at the gNB at time t2. The second uplink transmission \textcircled{2} occurs at time t2 which is between the first paging occasion PO₁ and the second paging occasion PO₂ and is received at the gNB at time t4. The third uplink transmission \textcircled{3} occurs at time t5 between the second paging occasion PO₂ and the third paging occasion PO₃ and is received at the gNB at time t6. Again, the gNB provides the respective feedbacks for the uplink transmissions \textcircled{1}, \textcircled{2} and \textcircled{3}, and the first feedback \textcircled{1} for the first uplink transmission is transmitted using the DCI at paging occasion PO₁, the second feedback \textcircled{2} is transmitted at the paging occasion PO₂ and the third feedback \textcircled{3} is transmitted at the paging occasion PO₃.

In accordance with the embodiments described so far, the HARQ feedback is provided for a single uplink transmission. However, in accordance with further embodiments, the HARQ feedback may be bundled for some or all of the uplink transmissions performed by the UE during a certain time period, and the bundling of the uplink transmission may be either in time or in frequency.

FIG. 8 illustrates embodiments employing a bundled feedback for a plurality of uplink transmissions. FIG. 8(a) illustrates a UE being in the RRC_INACTIVE state or in the RRC_IDLE state that transmits, for example using configured grants or pre-configured resources, at times t1 to t3 respective uplink transmissions \textcircled{1}, \textcircled{2} and \textcircled{3} to the gNB. The gNB receives the three transmissions at respective times t4 to t6. At the gNB a bundled HARQ feedback for all three uplink transmissions is created and, in the embodiment depicted in FIG. 8(a), the bundled HARQ feedback is transmitted at the second paging occasion PO₂ using the paging DCI in a way as described above.

FIG. 8(b) illustrates another embodiment for a bundled feedback for a plurality of uplink transmissions. In this embodiment, the UE, which, again, is in the RRC_INACTIVE state or in the RRC_IDLE state, performs three uplink transmissions \textcircled{1}, \textcircled{2} and \textcircled{3} to the gNB, a first uplink transmission \textcircled{1} at a time t1 that is received at the gNB at a time t2. The second uplink transmission \textcircled{2} is performed at a time t3 and is received at a time t4 at the gNB. The first and second uplink transmissions \textcircled{1} and \textcircled{2} are ahead of the first paging occasion PO₁ illustrated in FIG. 8(b). A third uplink transmission \textcircled{3} is performed at time t5 that is between the first paging occasion PO₁ and the second paging occasion PO₂. The third uplink transmission \textcircled{3} is received at the gNB at a time t6. Responsive to the three uplink transmissions, the gNB creates a bundled HARQ feedback that is transmitted to the UE using the paging DCI in a way as described above at the time of the second paging occasion PO₂.

In accordance with embodiments using the bundled feedback, the gNB may indicate in the bundled feedback for each of the transmissions the acknowledgement and/or the non-acknowledgement. In accordance with other embodiments, rather than signaling in the feedback transmitted during the paging occasions the detailed feedback information, only an overall ACK or an overall NACK may be transmitted using, for example, only a single bit in the paging DCI. In case a NACK is received, the UE performs an operation so as to obtain more details about the feedback from other messages to be received at configured or pre-configured locations in time/frequency, for example by searching for a different DCI format in a predefined search space, like a CORESET #0. The detailed feedback may indicate whether all of the transmissions in the bundled feedback were non-successful or which of the transmissions indicated in the bundled feedback were successful, i.e., received a ACK and which received a NACK, i.e., which were non-successful. A detailed feedback may include scheduling information for the UE to perform a retransmission for the failed UL transmission(s). The scheduling information may be essential and may also be transmitted for a single UL transmission. Other information may be the UL transmit power and a code-rate, like MCS, however, this is linked to the scheduling information.

HARQ Feedback in a New DCI

The above-described embodiments use the paging DCI, like the one in the Table 1 above, for signaling the feedback, however, in accordance with other embodiments, rather than using the above-described paging DCI, a new DCI may be employed for providing a feedback, like a HARQ feedback, for small data UL transmissions. Such a new DCI may be used to carry HARQ feedback information either as a per-transmission feedback or as a bundled feedback for some or all of the uplink transmissions performed by a UE during a certain period of time. In accordance with embodiments, the new DCI scrambled with the P-RNTI or the dedicated RNTI or the C-RNTI in case the UE is in the RRC_INACTIVE state, or the I-RNTI has a length that is the same as the length of the paging DCI, like the DCI format 1_0 depicted in the Table 1 above, however, the new DCI is different from the paging DCI in that it has an information element, IE, that is different from the paging DCI thereby allowing to differentiate the new DCI and the paging DCI. For example, the additional IE of the new DCI may be one bit long or x bits long. Keeping the same lengths as the existing paging DCI is advantageous as it allows reducing the number of blind decoding attempts at the UE, thereby improving the power efficiency. In accordance with other embodiments, the new DCI may have a length different from the length of the paging DCI thereby allowing the differentiating of the DCIs by their lengths. In accordance with this embodiment employing the new DCI, following an uplink transmission by the UE and during the subsequent paging occasions of the UE, the UE, in addition to the paging DCI, also monitors the POs for the new DCI for decoding the HARQ feedback carried in the new DCI.

In accordance with an embodiment, the gNB may provide a new DCI, which is a DCI having a different format than the paging DCI. For example, the new DCI is to be transmitted at a paging occasion and is scrambled with the P-RNTI or with a dedicated RNTI or a C-RNTI in case the UE is in the RRC_INACTIVE mode, or with an I-RNTI. The new DCI may be employed by the gNB in case an uplink transmission from the UE is not decodable, i.e., in case of a NACK. In case the gNB is able to decode the uplink transmission, the acknowledgement may be indicated in the paging DCI, e.g., using a bit in a way as outlined above. In other words, the new DCI may include only the NACK message and the existing paging DCI may be employed, for example reusing the currently unused bits in a way that is described above, to transmit the ACK message. FIG. 9 illustrates an embodiment employing the above-described new DCI and the existing paging DCI for signaling a NACK/ACK for a transmission. The UE is assumed to be in an RRC_INACTIVE state or in an RRC_IDLE state and transmits at a time t1 a first uplink transmission \textcircled{1} to the gNB. For example, the first uplink transmission \textcircled{1} may occur at a first configured grant or first pre-configured resources in a way as described above with reference to FIG. 4. The gNB detects at time t2 that the uplink transmission \textcircled{1} is decodable and, therefore, transmits as a feedback an acknowledgement, ACK. In accordance with this embodiment, the acknowledgement is transmitted at the paging occasion PO₁ using the paging DCI as described in the previous embodiments by reusing one of the unused bits in the existing paging DCI, and the UE, responsive to receiving the paging DCI recognizes the acknowledgement. At a time t3 that is between the first and second paging occasions PO₁ and PO₂, the UE sends a second uplink transmission \textcircled{1} that is received at the gNB at time t4, however, the second uplink transmission is not decodable by the gNB and, therefore, a NACK is to be signaled as feedback to the UE. In accordance with this embodiment, the new DCI format is employed by the gNB for signaling the UE the NACK feedback at the paging occasion PO₂. Although FIG. 9 illustrates the feedback for a single uplink transmission, the principles in accordance with this embodiment are equally applicable for bundled feedback for one or more transmissions performed by the UE during a certain time period. For example, in case all uplink transmissions are successfully received at the gNB, an acknowledgement, ACK, may be transmitted for all uplink transmissions using a paging DCI as described above. In case of a non-successful receipt of one or more of the uplink transmissions the gNB may signal a NACK using the new DCI. The new DCI may only include a NACK indicating that at least one of the uplink transmissions is non-successful causing a retransmission of all uplink transmissions performed. In accordance with other embodiments, similar as in the embodiments described above, the new DCI may cause the UE to obtain more detailed feedback information from other locations in time/frequency, for example by searching for another DCI format in other locations indicating which of the uplink transmissions were successful and which of them were non-successful.

In accordance with yet other embodiments, rather than employing a new DCI for the NACK and the paging DCI for the ACK, the new DCI may be employed for signaling both the NACK and the ACK, in a similar way as described above with reference to FIG. 6 to FIG. 8. When compared to FIG. 6 to FIG. 8, in accordance with these embodiments, rather than using the paging DCI, the new DCI is used. FIG. 10 illustrates an embodiment for a HARQ feedback using a new DCI format during the UE PO. The UE is assumed to be in the RRC_INACTIVE state or in the RRC_IDLE state and transmits at a time t1 before the first paging occasion PO₁ an uplink transmission \textcircled{1} to the gNB, using for example, configured grants or pre-configured resources as described above with reference to FIG. 4. At time t2, the gNB receives the uplink transmission \textcircled{1} and, dependent on whether the gNB successfully decodes the uplink transmission or not, the HARQ feedback, either the ACK or the NACK, for the small data uplink transmission \textcircled{1} is transmitted during the paging occasion PO₁ of the UE using the new DCI that is scrambled with the P-RNTI or a dedicated RNTI or a C-RNTI in case the UE is near RRC_INACTIVE state, or by a I-RNTI. In accordance with further embodiments, the new DCI described above with reference to FIG. 10, may also be used for signaling a bundled feedback similar as described above with reference to FIG. 7 and FIG. 8.

In accordance with further embodiments employing the new DCI, in addition to containing the HARQ feedback information, for example the NACK or the ACK/NACK, the new DCI may also include scheduling information for a retransmission in case of a NACK. FIG. 11 illustrates an embodiment of a new DCI that includes, in case of a NACK, also scheduling information for a retransmission of the uplink transmission that is not successfully received at the gNB. In FIG. 11 the UE is assumed to be in the RRC_INACTIVE state or in the RRC_IDLE state and transmits at respective configured grants or pre-configured resources uplink transmissions \textcircled{1} and \textcircled{2} to the gNB. At time t1, an uplink transmission \textcircled{1} is performed by the UE that is received at the gNB at time t2. It is assumed that the first uplink transmission \textcircled{1} is successfully received so that the gNB, at paging occasion PO₁ may signal the ACK using either the new DCI explicitly indicating the ACK or using the paging DCI. At time t3 a second uplink transmission \textcircled{2} is performed that is received at the gNB at time t4, however, it is assumed that this transmission \textcircled{2} is not successfully received at the gNB which, therefore, signals a NACK to the UE. The NACK is signaled using the new DCI at paging location PO₂ and, the new DCI also includes scheduling information indicating time/frequency resources ReTx to be employed by the UE for a retransmission of the second transmission \textcircled{2}.

In accordance with embodiments, the scheduling information may include one or more of the following:
a time factor k (see FIG. 11) indicating when to perform the retransmission with regard to the current paging occasion,
a frequency offset with respect to a reference frequency,
an exact time/frequency allocation for the retransmission,
an information element indicating either a single feedback or a bundled feedback.

HARQ Feedback Indication in the Paging DCI or New DCI

In the embodiments described so far, the HARQ feedback is indicated in a paging message, like the paging DCI or the new DCI described above, that is provided at a paging occasion. However, the present invention is not limited to such embodiments. In accordance with other embodiments, rather than transmitting the actual HARQ feedback at the paging occasion, information where the HARQ feedback may be found is transmitted at the paging occasion. The indication of the HARQ feedback may be transmitted in a paging DCI, like the DCI format 1_0 shown in the above Table 1, by reusing the bits in the short message or the reserved bits. In accordance with embodiments, the indication may be the indication of a downlink feedback indicator, DFI, scheduling. The DFI is introduced in the current NR-U specification to signal an explicit acknowledgement, ACK, or a negative acknowledgement, NACK, to a UE due to an uncertainty of a channel access result from a listen before talk, LBT, procedure. This downlink feedback indicator may be employed in accordance with embodiments for signaling the actual feedback and the paging DCI indicates where the DFI may be found, i.e., indicates the DFI scheduling. Naturally, the inventive approach is not limited to DFI scheduling, rather, any other message may be employed for explicitly signaling the HARQ feedback, and where such a message is found may be signaled in the paging DCI or in the new DCI.

FIG. 12 illustrates embodiments indicating a message, like a DFI, including the explicit HARQ feedback for a single uplink transmission in a paging DCI or in a new DCI during a paging occasion. FIG. 12(a) illustrates a UE being in the RRC_INACTIVE state or in the RRC_IDLE state transmitting at time t1, using, for example, a configured grant or pre-configured resources, an uplink transmission that is received at the gNB at time t2. The UE monitors the paging occasions PO₁ to PO₃ and at PO₁ receives a paging message, like a paging DCI or a new DCI indicating the DFI at which the gNB transmits the feedback. In FIG. 12(a), the gNB, dependent on whether the uplink transmission is successful or non-successful, transmits the ACK/NACK at time t3 using the DFI to which the UE is directed via the paging message received at paging location PO₁ so as to obtain from the DFI the feedback indicating whether the uplink transmission is successful, ACK, or is non-successful, NACK.

FIG. 12(b) illustrates the transmission of HARQ feedback for different single uplink transmissions \textcircled{1}, \textcircled{2} and \textcircled{3} performed by the UE. Again, the UE is considered to be in the RRC_INACTIVE state or in the RRC_IDLE state and transmits, for example using respective configured grants or pre-configured resources, at times t1 to t3 respective uplink transmissions \textcircled{1}, \textcircled{2} and \textcircled{3}. The data received at the gNB at times t4 to t6. At the respective paging occasions PO₁ to PO₃, the UE receives the paging DCI or the new DCI indicating where feedback for an uplink transmission may be found, i.e., the DFI location is signaled and the gNB at times t7, t8 and t9 provides the feedback ACK/NACK\textcircled{1}, ACK/NACK\textcircled{2} and ACK/NACK\textcircled{3} using DFI1, DFI2 and DFI3 for the first uplink transmission \textcircled{1}, second uplink transmissions \textcircled{2} and third uplink transmissions \textcircled{3}, respectively.

FIG. 12(c) illustrates also the transmission of three uplink transmissions \textcircled{1}, \textcircled{2} and \textcircled{3}, similar as in FIG. 12 (b), however, the first uplink transmission \textcircled{1} is performed at a time t1 before the first paging occasion, and the feedback for the first uplink transmission \textcircled{1} is transmitted in DFI1 at time t3. The DFI1 is signaled to the UE in the paging DCI or the new DCI received at paging occasion PO₁. The second uplink transmission \textcircled{2} is performed between the first and second paging occasions PO₁ and PO₃ and the third uplink transmission \textcircled{3} is transmitted between the second and third paging occasions PO₂ and PO₃. The respective feedback information DFI2 and DFI3 is provided subsequent to the second and third paging occasions PO₁ and PO₃, respectively, and the locations are signaled by the respective new DCIs or the paging DCIs received at paging location PO₂ and paging occasion PO₃, respectively.

FIG. 13 illustrates embodiments for the indication of messages carrying the feedback, like a DFI indication, for a bundled feedback for some or all uplink transmissions performed by the UE during a certain time period in a paging DCI or in a new DCI during a paging occasion. FIG. 13(a) illustrates a situation in which the UE, which is in RRC_INACTIVE state or in the RRC_IDLE state, performs three uplink transmissions \textcircled{1}, \textcircled{2} and \textcircled{3} at times t1 to t3 before the first paging occasion PO₁ which are received at times t4 to t6 at the gNB. The gNB, responsive to the three uplink transmissions \textcircled{1}, \textcircled{2} and \textcircled{3} generates a bundled feedback that is transmitted in a control message, like the bundled DFI which is indicated to the UE in the paging DCI or in the new DCI received at paging occasion PO₂. Like in the embodiments described above, the bundled DFI may include a single feedback for the bundle transmission, either an ACK or a NACK, and in case of a NACK the UE may obtain detailed information about the feedback, for example, which of the uplink transmissions is successful and which is non-successful from another control message, like a different DCI format which is provided at locations which are configured or pre-configured in the UE. In accordance with other embodiments, the bundled DFI may include the detailed feedback for each of the uplink transmissions.

FIG. 13(b) illustrates another embodiment for a message, like a DFI, carrying a bundled feedback for some or all of the uplink transmission performed by the UE during a certain time period, and the position of the message is signaled or indicated in the paging DCI or in the new DCI during a paging occasion. The UE, which is in the RRC_INACTIVE state or in the RRC_IDLE state, performs a first transmission \textcircled{1} at time t1 which is before the first paging occasion PO₁ and which is received at time t2 at the gNB. A second transmission \textcircled{2} is performed at a time t3 between the first and second paging occasions PO₁ and PO₂ and is received at the gNB at time t4, and a third transmission \textcircled{1} is performed at time t5 which is also between the first and second paging occasions PO₁ and PO₂ and is received at time t6 at the gNB. The gNB creates a combined feedback and transmits that combined feedback at time t7 in the bundled DFI which is indicated to the UE in the paging DCI or in the new DCI received at paging occasion PO₂. The bundled DFI may indicate the feedback in a way as described above with reference to FIG. 13(a).

Thus, in accordance with the embodiments of FIG. 12 and FIG. 13, a DFI may be scheduled by the system for providing the feedback to a UE which is indicated for a certain uplink transmission or for a bundle of uplink transmissions in the paging DCI or in the new DCI during a paging occasion. The scrambling of the DCI carrying the information about the DFI may be performed, in accordance with embodiments, with the P-RNTI, or with a dedicated RNTI or a C-RNTI in case the UE is in the RRC_INACTIVE state, or with an I-RNTI. The DCI used may either be the above described paging DCI, like the DCI format 1_0 depicted in the Table 1 above, or the above described new DCI. The indication in the DCI may include one or more of the following:
a time factor k (see FIG. 12 and FIG. 13) indicating when to expect the HARQ feedback with respect to a current paging occasion,
a frequency offset with respect to a reference frequency,
an exact time/frequency allocation of the HARQ feedback, for example the DFI,
an IE indicating either a single or a bundled feedback.

In accordance with further embodiments, in addition to signaling the feedback in a specific message indicated by a DCI received at the paging occasion, in case of a NACK, also the scheduling information for a retransmission is included in the control message, like in the DFI. For example, a new DCI may be employed that may be referred to as a HARQ feedback DCI that, in addition to including the DFI information, also, in case of a NACK, includes scheduling information for the retransmission. The new DCI or new message including the feedback and the retransmission information may be transmitted in a way as described above in the DCI received at the paging occasion, like the paging DCI or the new DCI. FIG. 14 illustrates embodiments using the just described HARQ feedback DCI including the DFI and the scheduling information which is indicated at the paging occasion using a paging DCI or a new DCI. FIG. 14(a) and FIG. 14(b) illustrate embodiments for a feedback for single uplink transmissions, and FIG. 14(c) illustrates an embodiment for a bundled feedback for some or all of the uplink transmissions performed by a UE during a certain time period.

In FIG. 14(a) the UE, which is in the RRC_INACTIVE state or in the RRC_IDLE state, performs an uplink transmission at time t1 that is received at the gNB at time t2. The gNB determines that the uplink transmission is not decodable and, therefore, issues at time t3 a NACK feedback by transmitting the above described HARQ feedback DCI including the indication that the uplink transmission at time t1 is not successful and including the scheduling information for the retransmission of the uplink transmission not received at the gNB. The UE receives at paging occasion PO₁ a DCI, like the above mentioned paging DCI or the new DCI, including the indication where the HARQ feedback DCI is found so that the UE may monitor the respective resources and decode the HARQ feedback DCI so as to receive the feedback and, in the depicted embodiment, the information, ReTx Scheduling, where the retransmission is to be performed.

FIG. 14(b) illustrates a similar embodiment in which the UE at times t1 and t2, before the first paging occasion PO₁, transmits a first uplink transmission \textcircled{1} and a second uplink transmission \textcircled{2} received at the gNB at time t3 and at time t4. The first uplink transmission \textcircled{1} is not successfully received at the gNB so that at time t5 the gNB signals a NACK\textcircled{1} in a way as described above with reference to FIG. 14(a). It is assumed that the second transmission \textcircled{2} at time t2 is successfully received at the gNB so that the gNB at time t6 indicates the feedback ACK\textcircled{2} in a way as described above with reference to FIG. 12(a) using a DCI only including the ACK but no information for the retransmission scheduling.

FIG. 14(c) illustrates the use of a bundled feedback, and the UE transmits at times t1 to t3 before the paging occasion PO₁ the three uplink transmissions \textcircled{1}, \textcircled{2} and \textcircled{3} received at the gNB at time t4 to time t6. The gNB determines whether the respective transmissions are received successfully or not and creates a feedback. In case all transmissions are successfully received, a single combined feedback may be provided in a way as described in FIG. 13(a) using the DFI without an indication of retransmission resources. In case some or all of the uplink transmissions are not decodable at the gNB, the feedback at time t7 is a NACK, and the HARQ feedback DCI is employed to signal the NACK together with the information, ReTx scheduling, about the retransmission resources available for the retransmission of one or more of the uplink transmissions. The feedback at time t7 may signal in the DFI for each of the uplink transmissions whether it is successfully or non-successfully received at the gNB, and the UE is informed at the paging occasion PO₂ using the new DCI or the paging DCI about where the HARQ feedback DCI is provided so that the respective occasion may be monitored and the ReTx scheduling information may be decoded.

In accordance with embodiments, the scheduling information may include one or more of the following:
a time factor k (see FIG. 14) indicating when to perform the retransmission with regard to the current paging occasion,
a frequency offset with respect to a reference frequency,
an exact time/frequency allocation for the retransmission,
an information element indicating either a single feedback or a bundled feedback.

### UE Monitoring Behavior for HARQ-ACK Related DCIs

In the embodiments described above, the UE monitors HARQ related DCIs. In accordance with further embodiments, the UE monitors the paging occasions for HARQ related DCIs only in case the UE performs a transmission in a period preceding the monitored paging occasion, otherwise it monitors the paging occasion only for paging relating information.

Mapping of HARQ Processes

In accordance with further embodiments, an implicit mapping of HARQ processes and the timing of the performed transmission is implemented. As described above, the uplink transmission performed by the UE without changing its RRC state may occur at configured grants or pre-configured resources. In case multiple transmission opportunities, like multiple configured grant occasions or multiple pre-configured resources, are used in a period between two paging occasions, the gNB may indicate a HARQ process ID in the DCI scheduling the corresponding retransmission opportunity to prevent any confusion. For example, the HARQ process ID may be determined based on the timing information, such as a slot number, a frame number or an index of the configured grant or of the pre-configured resources used within the PO interval for the uplink transmission.

FIG. 15 illustrates an embodiment of a CG index-based derivation of HARQ process IDs in accordance with which a UE uses the HARQ process ID associated with the CG index used for a transmission. FIG. 15 illustrates two configured grant configurations config #1 and config #2 defining occasions where the UE may transmit small data to the gNB. The configured grants occur with the indicated CG periodicity and the configured grants in accordance with config #1 and in accordance with config #2 are offset with respect to each other, either completely or in part. Within the time period or PO periodicity between two paging occasions PO₁ and PO₂ there are five configured grant occasions available for performing an uplink, three configured grant occasions of config #1 and two configured grant occasions of config #2, referred to in FIG. 15 as CG1 to CG5. When considering the interval between the paging occasions PO₁ and PO₂, the respective configured grant occasions of config #1 and config #2 have assigned therewith respective HARQ process IDs based on the timing the respective configured grant occasions occur. Within the PO interval or PO periodicity between paging occasions PO₁ and PO₂, the first CG occasion CG1 is associated with config #1, for which HARQ process ID=0. The second CG occasion, CG2, is associated with the CG config #2 for which HARQ process ID=1, and so on. In the depicted embodiment it is assumed that there is no data for an uplink transmission to the gNB at occasions CG1, CG3 and CG4, however, following the occasion CG1, data for an uplink becomes available and is transmitted by the UE using occasion CG2 of config #2.

The uplink transmission from the UE to the gNB at CG2 has associated therewith the HARQ process ID associated with the respective CG-config #2, i.e., HP-ID=1. The UE has no data to be transmitted at CG3 and CG4, however, following CG4, data becomes available to be transmitted to the gNB and is transmitted at CG5 using a CG from the config #1 having associated the HARQ process ID=4 so that the uplink transmission is transmitted together with an indication of the HP-ID=4. Thus, the respective uplink transmissions performed by the UE within the PO interval also indicate the HARQ process ID which may be indicated by the gNB in the DCI scheduling for the corresponding retransmission. Other embodiments may use pre-configured resources.

Additional Paging Occasions after an UL Transmission

In the embodiments described so far, the UE only monitors the conventional paging occasion for the feedback related DCIs, in case a transmission occurred before the respective paging occasion. The system or network may employ a UE configuration that also includes discontinuous reception, DRX, cycles. For example, UE parameters may include the just-mentioned discontinuous reception cycle, the UE_ID, a number of total paging frames in a DRX cycle, and a paging frame offset for the calculation or determination of paging occasions, POs. For a certain configuration of these parameters, the periodicity or interval of the POs may extend over a longer period leading to delays in the HARQ feedback when it is provided only at the paging occasions as indicated in the embodiments described so far. In certain situations or applications, such a delay may not be desired and further embodiments of the present invention address this issue by providing additional paging locations, also referred to as network configured additional paging occasions or UE indicated additional paging occasions. In other words, in accordance with further embodiments, feedback related information, like feedback related DCIs, may be monitored at additional paging occasions between regular or default paging occasions as determined by the UE configuration, for example on the basis of the discontinuous reception cycle. In accordance with embodiments, the additional paging occasions may be used in addition to the default paging occasions or may be used instead of the default paging locations for monitoring four feedback related information, like HARQ-feedback related DCIs. Any of the above-described embodiments for providing the feedback may be applied for transmitting the feedback at or during the additional paging occasions provided in accordance with the present embodiment.

In accordance with embodiments, the additional paging occasions may be network or explicitly configured. To address the issue regarding undesired delays for providing the HARQ feedback, the network, for example the gNB, may configure a number of additional paging occasions, POs, also referred to as APO_N, following an uplink transmission of a UE. This is advantageous as it reduces the delay in transmitting the HARQ feedback. The network, like the gNB, may configure the APO_N and communicate this to the UE using RRC signaling or using a downlink control information, DCI, message. The APO_N may be dynamic or fixed or semi-static in time. FIG. 16 illustrates embodiments of configured additional paging occasions for different values of the parameter APO_N with which the UE is configured or pre-configured. In FIG. 16, three conventional or default paging occasions are assumed, and in the PO interval or the interval between two adjacent paging occasions K additional paging occasions, illustrated as hatched blocks, are provided.

FIG. 16(a) illustrates this concept in general. The UE has the default paging occasions PO₁, PO₂ and PO₃, and the gNB configures the UE with K additional paging occasions so that APO_N=K. Within the PO interval, i.e., within the period between two subsequent POs, K additional paging occasions are provided, and besides the number of additional paging occasions, the gNB also signals the following information to the UE: The additional information may (1) indicate when to start monitoring these additional PO(s), i.e., an offset value from the current PO, (2) include a PO monitoring based on the configured DRX cycle, e.g., by updating the DRX cycle, the location of the PO(s) is known, and the PO(s) and DRX cycles may always by in sync, (3) indicate which PO(s) to monitor, which may be based on the bitmap as shown in FIG. 18. As mentioned above, at the additional paging occasions, HARQ-feedback related DCIs may be received, thereby providing the HARQ feedback for uplink transmission to the UE to the gNB with a delay that is shorter than the PO periodicity between adjacent default paging occasions.

FIG. 16(b) to FIG. 16(k) illustrate various embodiments employing the additional paging occasions for receiving feedback for single transmissions or bundled feedback for one or more uplink transmission performed by a UE during a certain period of time.

FIG. 16(b) to FIG. 16(f) illustrates embodiments in which the UE is configured by the gNB with two additional paging occasions between adjacent default paging occasions. In these figures, the default paging occasions are paging occasions PO₁, PO₄ and PO₇, and between default paging occasions PO₁ and PO₄ the additional paging occasions PO₂ and PO₃ are provided, and between the default paging occasions PO₄ and PO₇ the additional paging occasions PO₅ and PO₆ are provided. The UE is in the RRC_INACTIVE state or in the RRC_IDLE state and performs one or more uplink transmissions to the gNB using, for example, one or more configured grant occasions or pre-configured resources. In FIG. 16(b), the UE performs an uplink transmission at time t1 which is received at time t2 at the gNB. The gNB determines the successful/non-successful receipt of the uplink transmission and transmits at time t3 the HARQ feedback using, for example, a paging DCI or a new DCI as described in the proceeding embodiments, at the additional paging location PO₂.

In FIG. 16(c) the UE transmits at times t1 and t2 before the first default paging location PO₁, the first uplink transmission \textcircled{1} and the second uplink transmission \textcircled{2} that are received at the gNB at time t3 and at time t4. For the different uplink transmissions, the gNB provides the HARQ feedback and transmits at time t5 the HARQ feedback for the first uplink transmission \textcircled{1} at the additional paging occasion PO₂, and the HARQ feedback for the second uplink transmission \textcircled{2} at time t6 at the additional paging occasion PO₃.

The uplink transmissions may also occur between the default paging occasions or between additional paging occasions. In FIG. 16(d) the UE performs a first uplink transmission \textcircled{1} at time t1 before the first default paging occasion PO₁ that is received at time t2 by the gNB. At time t3 the gNB provides the HARQ feedback for the first uplink transmission \textcircled{1} at the first additional paging occasion PO₂. Between the first and second additional paging occasions PO₂ and PO₃ between the default paging occasions PO₁ and PO₄ the UE performs a second uplink transmission \textcircled{2} at time t4 that is received at time t5 at the gNB. At time t6 the gNB sends the HARQ feedback for the second transmission \textcircled{2} at the additional paging occasion PO₅.

FIG. 16(e) illustrates an embodiment using a bundled HARQ feedback to be provided at an additional paging occasion. At times t1 to t3 before the first default paging occasion PO₁ the UE transmits three uplink transmissions \textcircled{1}, \textcircled{2} and \textcircled{3} to the gNB received at time t4 to time t6. At time t7 the gNB provides a bundled HARQ feedback at the additional paging occasion PO₃.

FIG. 16(f) also illustrates an embodiment for a bundled feedback, however, the first uplink transmission \textcircled{1} is performed by the UE at the time t1 before the first default paging occasion PO₁ and is received at time t2 at the gNB. The second uplink transmission \textcircled{2} is performed at time t3 following the default paging occasion PO₁ and is received at time t4 at the gNB. At time t5 the gNB provides for the bundled HARQ feedback at the additional paging location PO₅.

FIG. 16(g) to FIG. 16(k) illustrate embodiments in which the gNB configures the UE with three additional paging occasions within a PO interval, i.e., APO_N=3. FIG. 16(g) illustrates an embodiment in which the UE performs an uplink transmission at time t1 before the first default paging occasion PO₁. The transmission is received at the gNB at time t2 which, at time t3, provides a HARQ feedback about the successful/non-successful receipt of the uplink transmission at the additional paging occasion PO₄.

FIG. 16(h) illustrates the transmission of more than one uplink transmission and the provision of respective single HARQ feedbacks by the gNB. The UE, in the depicted embodiment, transmits three uplink transmissions \textcircled{1}, \textcircled{2} and \textcircled{3} at time t1 to time t3 before the first default paging occasion PO₁ which are received at time t4 to time t6 at the gNB. At time t7, the gNB provides the feedback for the first transmission \textcircled{1} at the additional paging occasion PO₂, at time t8 the HARQ feedback for the second transmission \textcircled{2} at the additional paging occasion PO₆, and at time t9 the HARQ feedback for the third transmission \textcircled{3} at the default paging occasion PO₉.

FIG. 16(i) illustrates an embodiment in which the UE performs multiple uplink transmissions at different locations ahead of the first paging occasion 1 and between the respective default paging occasions. The UE performs a first uplink transmission \textcircled{1} at time t1 before the first default paging occasion PO₁ that is received at time t2 by the gNB. At time t3 the gNB provides the HARQ feedback for the first uplink transmission \textcircled{1} at the first additional paging occasion PO₂. At time t4 between the additional paging occasions PO₃ and PO₄ the UE performs a second uplink transmission \textcircled{2} that is received at time t5 at the gNB. At time t6 the gNB provides the HARQ feedback for the second feedback transmission \textcircled{2} at the additional paging occasion PO₆. At time t7, between the additional paging occasions PO₆ and PO₇ the UE performs a third uplink transmission \textcircled{3} that is received at time t8 at the gNB. At time t9 the gNB provides the HARQ feedback for the third uplink transmission \textcircled{3} at the default paging occasion PO₉.

FIG. 16(j) and FIG. 16(k) illustrate embodiments for a bundled feedback. In FIG. 16(j) the UE performs three uplink transmissions \textcircled{1}, \textcircled{2} and \textcircled{3} at time t1 to time t3 before the first default paging occasion PO₁ which are received at time t4 to time t6 at the gNB. At time t7, the gNB provides a bundled HARQ feedback at the additional paging occasion PO₄.

In FIG. 16(k), the respective uplink transmissions occur at different paging occasion intervals. More specifically, the UE performs a first uplink transmission \textcircled{1} at time t1 before the first default paging occasion PO₁ that is received at time t2 at the gNB. A second uplink transmission \textcircled{2} is performed by the UE at time t3 that is between the default paging occasion PO₁ and the additional paging occasion PO₂. The second uplink transmission \textcircled{2} is received at time t4 at the gNB. Following the additional paging occasion PO₃ the UE performs at time t5 a third uplink transmission \textcircled{3} received at time t6 at the gNB. At time t7, the gNB provides the bundled HARQ feedback at the additional paging location PO.

It is noted that the HARQ feedback provided by the gNB may be provided at any other of the PO occasions illustrated in FIG. 16, at one or more of the default paging occasions and/or at one or more of the additional paging occasions.

The UE may be configured by the gNB or the network with a DRX cycle, together with the additional paging occasions, wherein the DRX cycle is selected or updated so as to be sufficiently long to also monitor the additional paging occasion, thereby avoiding the undesired need to extend an initially configured DRX-on duration timer, thereby avoiding a decrease in the power efficiency at the UE. The power saving may be achieved basically by switching off the modem for the time period of the DRX-off duration. When extending the DRX-on duration then the modem is ON for longer. In accordance with further embodiments, rather than configuring the additional paging occasions by the network, like the gNB, the additional paging occasions may also be implicitly configured and may be indicated by the UE. For example, in accordance with the current 3 GPP specifications the network may configure the UE with the set of DRX cycles, for example short and long DRX cycles. The UE, e.g., based on traffic and quality of service, may indicate to the network during an uplink transmission the DRX cycle used by the UE to monitor the HARQ feedback for the corresponding uplink transmission. In this case, the network, like the gNB, is implicitly aware of the additional monitoring occasions available and provides the HARQ feedback on one or more of those occasions. In accordance with embodiments, in case there is no indication of a DRX type in the uplink transmission, the gNB knows that the UE only monitors the default paging occasions as described in the embodiments above with reference to FIG. 6 to FIG. 14 so that the gNB does not provide the feedback on any additional paging occasions.

FIG. 17 illustrates embodiments for an implicit configuration of additional paging occasions responsive the indication of a DRX type together with an uplink transmission by the UE. In FIG. 17, in a similar way as explained above with reference to FIG. 16(a), a number of default paging occasions are illustrated between which additional paging occasions, indicated by the hatched blocks, are provided. The PO(s) may be calculated based on a formula. Based on the DRX type and some other parameters, the gNB is aware of the PO(s).

FIG. 17(a) illustrates an embodiment in which the UE at time t1, which is before the first default paging occasion PO₁, performs an uplink transmission and indicates the DRX type 1. The transmission is received at the time t2 at the gNB. On the basis of the information about the DRX type, the gNB is aware that the UE monitors, in addition to the default paging occasions PO₁, PO₅ and PO₉, also the additional paging occasions PO₂ to PO₄ and PO₆ to PO₈ within the PO intervals between PO₁ and PO₅ and between PO₅ and PO₉, respectively. At any one of the paging occasions, either the default ones or the additional ones, the gNB may provide the HARQ feedback for the uplink transmission received at time t2.

FIG. 17(b) illustrates an embodiment in which the UE, at the time t1, which is ahead of the first default paging occasion PO₁, performs an uplink transmission indicating DRX type 2. The uplink transmission and the indication of the DRX type is received at the gNB at time t2 and, based on the DRX type 2, the gNB is aware that the UE monitors two additional paging occasions between two default paging occasions, namely additional paging occasions PO₂ and PO₃ between the default paging occasions PO₁ and PO₄, and the additional paging occasions PO₅ and PO₆ between the default paging occasions PO₄ and PO₇. At any of the paging occasions indicated in FIG. 17(b) the gNB may provide the HARQ feedback for the uplink transmission received at time t2.

FIG. 17(c) illustrates the present embodiment in more general terms. At time t1, the UE performs the transmission and indicates a certain DRX type X. The gNB receives the uplink transmission at time t2 together with the DRX type X, and dependent on the value of X, the k additional paging occasions PO₁ to POₖ that the UE monitors between adjacent default paging occasions PO₁ and PO₂ and PO₂ and PO₃, respectively.

FIG. 17(d) illustrates an embodiment in which multiple uplink transmissions are performed by the UE at time t1 to time t3 that are received at times t4 to t6 at the gNB together with the respective DRX types associated with the uplink transmissions, in the depicted embodiments the different DRX types X, Y and Z, dependent on the signal DRX types, the gNB is aware of those additional occasions where the UE performs a monitoring for HARQ-related DCIs, namely the k additional paging occasions PO₁ to POK between the respective default paging occasions PO₁, PO₄ and PO₇.

In accordance with further embodiments, the additional paging occasions may be configured, explicitly or implicitly, for different UEs using a so-called monitoring bitmap. More specifically, once the additional paging occasions are configured, different users may be configured with a bitmap which indicates which of the additional paging occasions are to be monitored by the UE. This approach is advantageous as it provides the gNB with an additional degree of freedom for user separation in case of more than one user and allows the support of different traffic types. From the UE perspective, monitoring a lesser number of paging occasions may improve the power efficiency at the UE. The number of bits used to represent a bitmap may be dependent on the configured value of APO_N in the explicit case and the DRX type in the implicit case. For example, in the explicit case, if APO_N defines K additional POs, the bitmap may have a length of K bits. In the implicit case, the gNB may configure different bitmaps for the different DRX types, which may be configured semi-statically using an RRC message or dynamically in a DCI. Embodiments employing the monitoring bitmap are now described with reference to FIG. 18 and FIG. 19.

FIG. 18 illustrates embodiments of network configured additional paging occasions with APO_N=2 with different bitmap configurations. In FIG. 18, the network configured APO_N=2 means that between two default paging occasions two additional paging occasions are provided as indicated by the hatched blocks, and a first UE1 and a second UE2 are configured with respective additional paging occasions PO₂, PO₃ and PO₅, PO₆ between the default paging occasions PO₁, PO₄ and PO₇. In the embodiment of FIG. 18(a), all UEs, namely UE1 and UE2 are configured to use all additional paging occasions configured by the gNB so that the respective bitmaps for both UEs have the value “11” indicating that all additional paging occasions between two adjacent default paging occasions are to be monitored.

FIG. 18(b) illustrates an embodiment in accordance with which only a subset of the additional paging occasions is to be monitored. Again, the gNB configured between adjacent default paging occasions the additional paging occasions, i.e., APO_N=2. However, in the depicted embodiment, UE1 and UE2 are to use only the first additional paging occasion PO₂, PO₅ and the second additional paging occasion PO₃, PO₆, respectively, so that the UE1 is configured with a bitmap having a value of “10” indicating that only the first additional paging occasion PO₂, PO₅ is to be monitored by the UE1, but not the second additional paging occasion PO₃, PO₆, as indicated by the dashed representation of the additional paging occasions PO₃, PO₆. UE 2 is provided with a bit map having a value of “01” indicating that only the second paging occasion PO₃, PO₆ is to be monitored, but not the first additional paging occasion PO₂, PO₅, as indicated by the dashed representation of the additional paging occasions PO₂, PO₅.

FIG. 19 illustrates other embodiments employing different bitmap configurations for a network configured number of additional paging occasions with APO_N=3. Thus, the gNB configures three additional paging occasions between two default paging occasions, as indicated by the hatched blocks in FIG. 19, of which, in accordance with the depicted embodiments, some or all may be used by respective UEs as indicated by the bitmaps provided by the gNB. FIG. 19(a) illustrates an embodiment in which the respective UEs UE1 and UE2 are to monitor all additional paging occasions PO₂ to PO₄ and PO₆ to PO₉, respectively, as configured by the gNB so that the respective bit maps have a value of “111”.

FIG. 19(b) illustrates an embodiment in which the respective UEs are to monitor different subsets of the additional paging occasions. UE1, as is illustrated in FIG. 19(b) monitors only the first one of the additional paging occasions PO₂, PO₆ in the respective paging intervals, but not the second and third additional paging occasion PO₃, PO₄, PO₇, PO₈ as indicated by the dashed representation of these additional paging occasions. UE2 monitors two additional paging occasions PO₃, PO₄ and PO₇, PO₈, but not the first additional paging occasion PO₂, PO₆, as indicated by the dashed representation of those additional paging occasions. Thus, For UE1 the bitmap has a value of “100”, and for UE2 the bitmap has a value of “011”.

In accordance with embodiments, a UE may be provided with a certain stopping criterion to stop monitoring additional paging occasions. More specifically, in case a UE is configured, explicitly or implicitly, with multiple additional paging occasions between default paging occasions, the UE, without a stopping criterion, monitors all additional paging occasions. However, this may lead to unnecessary monitoring actions and associated unnecessary power consumption, for example in case a feedback for an uplink transmission has already been received. In other words, in accordance with embodiments, the UE monitors the additional paging occasions only until it receives a HARQ feedback for the uplink transmission. After that, the UE may return to monitoring only the default paging occasions as calculated, for example, from the paging related parameters. This approach is advantageous as the stopping criterion improves the power efficiency at the UE. The stopping criterion is valid for both explicit and implicit additional monitoring occasions, and in the explicit case the UE may not monitor the additional paging occasions as configured by the parameter APO_N and switch back to the previous DRX cycle if necessary. In the implicit case, the UE may switch back to a longer DRX cycle to wake up less frequently so as to improve power efficiency. FIG. 20 illustrates embodiments of a UE stopping monitoring the additional paging occasions, illustrated as hatched blocks, once a HARQ feedback for an uplink transmission is received. In FIG. 20 an explicit configuration of the additional paging occasions is assumed, and FIG. 20(a) to FIG. 20(c) illustrates an embodiment employing two additional paging occasions, i.e., APO_N=2. Between the default paging occasions PO₁, PO₄ and PO₇ two additional paging occasions PO₂, PO₃ and PO₅, PO₆ are configured.

In FIG. 20(a) the UE performs an uplink transmission at time t1 ahead of the initial or first default paging occasion PO₁. The uplink transmission is received at the gNB at time t2 and, at time t3, the gNB provides the HARQ feedback for the uplink transmission at the additional paging occasion PO₅. Responsive to receiving the HARQ feedback at paging occasion PO₅, the UE stops monitoring the remaining additional paging occasions, in this embodiment the additional paging occasion PO₆ which is indicated in dashed lines. Once the monitoring of the additional paging occasions is stopped, the UE continues to monitor the default paging occasions, and in the embodiment of FIG. 20(a) the next paging occasion monitored is default paging occasion PO₇.

FIG. 20(b) illustrates an embodiment in which the UE, at time t1 and time t2, performs two uplink transmissions \textcircled{1} and \textcircled{2} received at the gNB at time t3 and time t4. At time t5 the gNB provides the HARQ feedback for the first uplink transmission \textcircled{1} at the first additional paging occasion PO₂. Since not all of the feedbacks for all of the transmissions are received at the UE at that time, the UE continues to monitor the additional paging occasions. At time t6, the gNB provides the HARQ feedback for the second uplink transmission \textcircled{2} at additional paging occasion PO₃ so that the UE, in this embodiment, stops monitoring the additional paging occasions, i.e., the additional paging occasions PO₅ and PO₆ are not monitored anymore by the UE.

FIG. 20(c) illustrates an embodiment using a bundled HARQ feedback. The UE performs at time t1 and time t2 respective uplink transmissions \textcircled{1} and \textcircled{2} received at time t3 and time t4 of the gNB. The gNB creates a bundled HARQ feedback that is provided to the UE as t5 at additional paging occasion PO₃. Responsive to the receipt of the bundled HARQ feedback the UE stops monitoring the remaining additional paging occasions PO₅ and PO₆.

FIG. 20(d) to FIG. 20(f) illustrates embodiments in which the gNB configures three additional paging occasions, APO_N=3, so that between the default paging occasions PO₁, PO₅ and PO₉ the additional paging locations PO₂, PO₃, PO₄ and PO₆, PO₇, PO₈, respectively, are configured. In FIG. 20(d) the UE performs an uplink transmission at time t1 that is received by the gNB at time t2. At time t3, the gNB provides the HARQ feedback for the uplink transmission at the additional paging location PO₃ and stops monitoring the remaining additional paging occasions PO₄, PO₆, PO₇ and PO₈. The next paging occasion monitored by the UE is the default paging occasion PO₅.

In FIG. 12(e), the UE performs uplink transmissions \textcircled{1}, \textcircled{2} and \textcircled{3} at time t1, time t2 and time t3 and stops monitoring only once the feedback for all of the uplink transmission is received. The uplink transmissions \textcircled{1}, \textcircled{2} and \textcircled{3} are received at the gNB at time t3, time t4 and time t6, and at time t7 the HARQ feedback for the first uplink transmission \textcircled{1} is provided at the additional paging occasion PO₂. The HARQ feedback for the second uplink transmission \textcircled{2} is provided at time t8 at the additional paging occasion PO₄, and the HARQ feedback for the third uplink transmission \textcircled{2} is provided at time t9 at the default paging occasion PO₅. The UE stops monitoring the additional paging occasions PO₆, PO₇ and PO₈ after receiving the HARQ feedback for all uplink transmissions and the next paging occasion monitored is the default paging occasion PO₉.

FIG. 20(f) illustrates an embodiment using bundled feedback. The UE performs three uplink transmissions \textcircled{1}, \textcircled{2} and \textcircled{3} at time t1 to time t3 which are received at the gNB at time t4 to time t6. At time t7, the gNB provides the bundled feedback for all uplink transmissions at paging occasion PO₄, and responsive to the receipt of the bundled HARQ feedback, the UE stops monitoring the additional paging occasions PO₆, PO₇ and PO₈ so that, in the depicted embodiment, the next paging occasion monitored by the UE is the default paging occasion PO₅.

### Small Data Indication in the Downlink

In accordance with further embodiments of the present invention, a transmission of small data may be indicated in the downlink. In accordance with such embodiments, the short message and/or the reserved bits in the paging DCI, like the DCI described in the above Table 1, may be used to indicate the presence of a small data downlink transmission. When receiving this indication from the gNB in the paging DCI, the UE continues to decode the small data transmitted from the gNB without triggering a change in the RRC state, i.e., without transitioning to the RRC_CONNECTED state. The small data may be directly transmitted to the UE in the specific message or may be scheduled in a new DCI. In accordance with embodiments, the UE may be configured to blind decode for the DCI format carrying the connector information regarding the small data transmission only in case the data indicator in the paging occasion is set to one. Both, the specific message and the new DCI scrambled with the P-RNTI, a dedicated RNTI or an I-RNTI may be employed, and may indicate one or more of the following elements:
a time factor k indicating when to expect the small data transmission in the downlink,
a one bit or x bit indicator for the present or absence of small data.

FIG. 21 illustrates an embodiment indicating the transmission of data, like small data, in a paging DCI. FIG. 21 shows a UE being in the RRC_INACTIVE state or the RRC_IDLE state and monitoring the default paging occasions PO₁, PO₂, and PO₃ for a paging message or for a paging DCI including, in accordance with the inventive approach, the indication of a small data downlink transmission. At a time t1, the gNB indicates at the second default paging occasion PO₂ the existence of a small downlink message, for example by setting one of the unused bits in the paging DCI transmitted at PO₂ to a specific value. In case the paging DCI also includes the downlink message itself, the UE continues to decode the message until the data is received. In accordance with other embodiments, in which the paging DCI includes the indication where the downlink message may be found, as depicted in FIG. 21, the UE retrieves the respective information about the DCI including the small data, and the UE monitors the indicated location for the additional DCI including the small data which is transmitted by the gNB at time t2. FIG. 21 illustrates the embodiment in which the indication includes the factor k indicating when to expect the small data transmission in the downlink using the DCI/small data message shown in FIG. 21.

In accordance with further embodiments, the small data DL transmission may also occur using the additional paging occasions described above.

Dedicated RNTI

In the above description of the embodiments of the present invention reference has been made to a dedicated RNTI that is used for indicating the message transmitted at the paging occasion indicating to the UE a transmission of HARQ feedback from the gNB or the transmission of a downlink small message. In accordance with embodiments, the dedicated RNTI is different from the P-RNTI and the I-RNTI and is designed specifically for the transmission or reception of small data to and from the UE, like the transmission of feedback information from the gNB to the UE or the transmission of data in the downlink from the gNB to the UE, i.e., to exchange information between the UE and the gNB without the need for an RRC state transition. The dedicated RNTI design may be employed in all of the embodiments described above.

In accordance with an embodiment, in the downlink transmission, as part of the paging DCI, an index indicating the RNTI to be used to decode the small data DCI or message may be transmitted. Similarly, for the HARQ feedback of uplink transmissions, the decoding of the DFI or other messages, like other DCI(s) may be indicated as an index as part of the paging DCI. The index corresponds to the RNTI value from a Table 1 known to both the UE and the gNB.

In accordance with other embodiments, the dedicated RNTI for small data related transmission may be indicated to the UE in an RRC message and may be valid semi-statically in time.

General

In the embodiments described above, reference has been mainly made to a RX UE receiving the location information from the TX UE in accordance with the inventive approach. However, the present invention is not limited to RX UEs, rather, the above described UE may also be TX UEs that provide the location information from the TX UE in accordance with the inventive approach to the RX UEs. For example, the UEs described herein may by a receiving UE or a transmitting UE in the SL communication.

In the above described embodiments, reference has been made to information elements that include X- and Y-coordinates. The location information, in accordance with all embodiments described herein, may also include information on a current height or altitude of the UE, for example, for flying UEs such as UAVs, drones, helicopters, planes. Moreover, the information element, in accordance with other embodiments, may include a motion vector or a direction of motion so as to allow refining the positioning information. The additional information about the altitude or height and/or the additional information about the motion vector or the direction of motion may be combined with any of the embodiments described above, for example, the position delta in accordance with the second aspect may be sent via the SCI and is linked to a height information that may sent via RRC.

Embodiments of the present invention have been described in detail above, and the respective embodiments and aspects may be implemented individually or two or more of the embodiments or aspects may be implemented in combination.

With regard to the above-described embodiments of the various aspects of the present invention, it is noted that they have been described in a certain environment in which a communication is between a transmitter, like a TX UE, and a receiver, like a gNB. However, the invention is not limited to such a communication, rather, the above-described principles may equally be applied also for a device-to-device communication over the sidelink, like a D2D, V2V or V2X communication.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments, the user device, UE, may be one or more of a mobile terminal, or a stationary terminal, or a cellular IoT-UE, or a vehicular UE, or a vehicular group leader (GL) UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity. The base station, BS, may be implemented as mobile or immobile base station and may be one or more of a macro cell base station, or a small cell base station, or a central unit of a base station, or a distributed unit of a base station, or a road side unit, or a UE, or a group leader (GL), or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 22 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### List of Acronyms and Symbols

BS Base Station
CBR Channel Busy Ratio
D2D Device-to-Device
EN Emergency Notification
eNB Evolved Node B (base station)
IE Information Element
FDM Frequency Division Multiplexing
LTE Long-Term Evolution
PC5 Interface using the Sidelink Channel for D2D communication
PPPP ProSe per packet priority
PRB Physical Resource Block
ProSe Proximity Services
RA Resource Allocation
SCI Sidelink Control Information
SL sidelink
sTTI Short Transmission Time Interval
TDM Time Division Multiplexing
TDMA Time Division Multiple Access
TPC Transmit power control/transmit power command
UE User Entity (User Terminal)
URLLC Ultra-Reliable Low-Latency Communication
V2V Vehicle-to-vehicle
V2I Vehicle-to-infrastructure
V2P Vehicle-to-pedestrian
V2N Vehicle-to-network
V2X Vehicle-to-everything, i.e., V2V, V2I, V2P, V2N

1. A user device, UE, for a wireless communication system, the wireless communication system comprising one or more base stations,
wherein the UE is in an RRC_INACTIVE state or in an RRC_IDLE state and is to monitor one or more paging occasions,
wherein the UE is to perform one or more uplink, UL, transmissions to the base station without entering an RRC_CONNECTED state, e.g., using a configured grant, CG, or pre-configured resources,
wherein the UE is to monitor one or more paging occasions following the one or more UL transmissions for a message from the base station, the message being associated with feedback information, e.g., HARQ feedback formation, for the one or more UL transmissions.

2. The user device, UE, of claim 1, wherein the feedback information comprises a feedback for a single UL transmission or a bundled feedback for a plurality of UL transmissions or a feedback for a number of HARQ processes.

3. The user device, UE, of claim 1, wherein the UE is to monitor a paging occasion not only for a paging-related message but also for a feedback related.

4. The user device, UE, of claim 1, wherein the message indicates a successful receipt, ACK, of the one or more UL transmissions at the base station and/or a non-successful receipt, NACK, of the one or more UL transmissions at the base station.

5. (canceled)

6. The user device, UE, of claim 1, wherein the message is a new DCI different from a paging DCI, the new DCI comprising the feedback information, and, optionally, scheduling information for a retransmission.

7. The user device, UE, of claim 6, wherein the new DCI comprises the same length as the paging DCI but comprises additional information, like an additional information element, IE, comprising one or more bits for differentiating the new DCI and the paging DCI, or the included CRC is scrambled with a another RNTI than the P-RNTI, or comprises a different length as the paging DCI.

8. (canceled)

9. (canceled)

10. (canceled)

11. The user device, UE, of claim 1, wherein, in case the feedback information comprises scheduling information for a retransmission one or more of the following is indicated:
a time factor indicating when to perform the retransmission with respect to the paging occasion at which the message is received,
a frequency offset with respect to a reference frequency,
an exact time/frequency allocation of the retransmission.

12. The user device, UE, of claim 1, wherein
the UE is to determine a successful receipt, ACK, of the one or more UL transmissions at the base station when the message is of a first type, and
the UE is to determine a non-successful receipt, NACK, of the one or more UL transmissions at the base station and, optionally, scheduling information for a retransmission, when the message is of a second type.

13. The user device, UE, of claim 12 wherein the message of the first type is a default paging DCI comprising feedback indicating a successful receipt, ACK, and the message of the second type is a new DCI different from a paging DCI, the new DCI comprising feedback indicating a non-successful receipt, NACK, and, optionally, scheduling information for a retransmission.

14. The user device, UE, of claim 12 wherein the message of the first type is a default paging DCI comprising no feedback, and the message of the second type is a new DCI different from a paging DCI, the new DCI not comprising feedback, but, optionally, scheduling information for a retransmission, wherein both the paging DCI and the new DCI comprise identification information associating the UL transmission with a single and/or bundled feedback.

15. The user device, UE, of claim 13, wherein the new DCI comprises the same length as the paging DCI but comprises additional information, like an additional information element, IE, comprising one or more bits for differentiating the new DCI and the paging DCI, or the included CRC is scrambled with a another RNTI than the P-RNTI, or comprises a different length as the paging DCI.

16. The user device, UE, of claim 12, wherein, in case the feedback information comprises scheduling information for a retransmission one or more of the following is indicated:
a time factor indicating when to perform the retransmission with respect to the paging occasion at which the message is received,
a frequency offset with respect to a reference frequency,
an exact time/frequency allocation of the retransmission.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A base station, BS, for a wireless communication system,
wherein the BS is to receive one or more uplink, UL, transmissions from a user device, UE, the UE being in an RRC_INACTIVE state or in an RRC_IDLE state and not entering an RRC_CONNECTED state for the transmission, and
wherein, following the one or more UL transmissions, the BS is to transmit a message to the UE at one or more paging occasions monitored by the UE, the message being associated with feedback information, e.g., HARQ feedback formation, for the one or more UL transmissions.

42. The base station, BS, of claim 41, wherein the feedback information comprises a feedback for a single UL transmission or a bundled feedback for a plurality of UL transmissions or a feedback for a number of HARQ processes regardless of the number of actually performed UL transmissions in the related period.

43. The base station, BS, of claim 41, wherein the BS is not to transmit the message, in case there is a paging of the UE from the radio access network or from the core network at the paging occasion, or in case there is a data transmission or reception at the paging occasion.

44. The base station, BS, of claim 41, wherein the message indicates a successful receipt, ACK, of the one or more UL transmissions at the base station and/or a non-successful receipt, NACK, of the one or more UL transmissions at the base station.

45. (canceled)

46. The base station, BS, of claim 41, wherein
the message is a new DCI different from a paging DCI, the new DCI comprising the feedback information, and
wherein, for differentiating the new DCI and the paging DCI, the new DCI comprises the same length as the paging DCI but comprises additional information, like an additional information element, IE, comprising one or more bits, or comprises a different length as the paging DCI.

47. (canceled)

48. (canceled)

49. (canceled)

50. (canceled)

51. The base station, BS, of claim 41, wherein
the message indicates that feedback is available for the one or more UL transmissions at a configured or pre-configured set of resources for a further message, like a DFI, the further message indicating a successful receipt, ACK, of the one or more UL transmissions at the base station and/or a non-successful receipt, NACK, of the one or more UL transmissions at the base station, and, optionally, scheduling information for a retransmission.

52. (canceled)

53. The base station, BS, of claim 52, wherein the message indicates one or more of the following:
a time factor indicating when to expect the further message with respect to the paging occasion at which the message is received,
a frequency offset with respect to a reference frequency,
an exact time/frequency allocation of the further message,
an information element, IE, indicating either a single or bundled feedback.

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. A method for a wireless communication system, the wireless communication system comprising one or more base stations, and a user device, UE, being in an RRC_INACTIVE state or in an RRC_IDLE state, the method comprising:
monitoring, by the UE, one or more paging occasions,
performing, by the UE, one or more uplink, UL, transmissions to the base station without entering an RRC_CONNECTED state, e.g., using a configured grant, CG, or pre-configured resources,
monitoring, by the UE, one or more paging occasions following the one or more UL transmissions for a message from the base station, the message being associated with feedback information, e.g., HARQ feedback formation, for the one or more UL transmissions.

69. (canceled)

70. (canceled)

71. (canceled)

72. (canceled)

73. (canceled)

74. (canceled)
